(19) United States
(12) Patent Application Publication
(10) Pub. No.: US 2026/0312539 A1
(43) Pub. Date: Oct. 8, 2026

(54) CURVE TRACERS

(71) Applicants: Joseph N. WEST, Everett, WA (US); Caleb AUSTIN, Everett, WA (US); Willard S. MACDONALD, Everett, WA (US); Fluke Corporation, Everett, WA (US)

(72) Inventors: Joseph N. West, Sebastopol, CA (US); Caleb Austin, Sebastopol, CA (US); Willard S. MacDonald, Sebastopol, CA (US)

(73) Assignee: Fluke Corporation, Everett, WA (US)

(21) Appl. No.: 19/480,421

(22) PCT Filed: May 3, 2024
(86) PCT No.: PCT/US2024/027852

§ 371 Date: Oct. 31, 2025

Related U.S. Application Data
(60) Provisional application No. 63/499,795, filed on May 3, 2023.

(51) Int. Cl. H02S 50/10

(52) U.S. Cl. CPC H02S 50/10

(57) ABSTRACT

Embodiments of the present disclosure relate to curve tracers and systems for testing PV modules. The I-V curve tracer may include a switch-mode power converter (SMPC) circuit. The I-V curve tracer may be configured to sweep an I-V curve of the PV circuit. Related devices, systems and methods are also possible.

### CROSS-REFERENCE TO RELATED APPLICATIONS

The present application claims priority to U.S. Provisional Patent Application No. 63/499.795, filed on May 3, 2023, the disclosure of which is hereby incorporated in its entirety.

### FIELD

Embodiments of the present disclosure relate to curve tracers, and associated systems, devices, circuits, and methods.

### BACKGROUND

Photovoltaic (PV) systems are ubiquitous contributors to worldwide energy production. Solar modules, or solar panels, within PV systems convert incident sunlight into electrical energy that may be fed through an inverter to a utility power grid, stored in battery banks, or locally consumed.

### BRIEF DESCRIPTION THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 illustrates an example system in which aspects of the present disclosure may be implemented;

FIG. 2 illustrates a model of a PV cell;

FIG. 3 depicts a portion of one type of curve tracer using a capacitive load;

FIG. 4 is a flowchart depicting a method of measuring an I-V curve with a capacitive load;

FIG. 5 depicts an example switch;

FIG. 6 is a plot including an I-V curve;

FIG. 7 depicts a block diagram of a PV system with module-level electronics;

FIG. 8 depicts a device including a curve tracer, according to various embodiments of the disclosure;

FIG. 9 is a flowchart depicting a method, according to various embodiments of the disclosure;

FIG. 10 is a flowchart depicting another method, in accordance with various embodiments of the disclosure;

FIG. 11 is a flowchart depicting another method, in accordance with various embodiments of the disclosure;

FIG. 12 depicts a device including a curve tracer, according to various embodiments of the disclosure;

FIG. 13 illustrates a switch-mode power converter (SMPC) “bleeder” circuit, in accordance with various embodiments of the disclosure;

FIG. 14 depicts a device including a SMPC curve tracer, according to various embodiments of the disclosure;

FIG. 15 illustrates quadrants of operation of a power conversion circuit, including an SMPC as a possible type, according to various embodiments of the disclosure;

FIG. 16 depicts a C'uk converter;

FIG. 17 depicts an SMPC, in accordance with various embodiments of the disclosure;

FIG. 18 is a flowchart depicting another method, in accordance with various embodiments of the disclosure;

FIG. 19 depicts another C'uk SMPC, in accordance with various embodiments of the disclosure;

FIG. 20 depicts another C'uk SMPC, in accordance with various embodiments of the disclosure;

FIG. 21 depicts a device including a curve tracer, according to various embodiments of the disclosure;

FIG. 22 is a plot of an I-V curve, according to various embodiments of the disclosure;

FIG. 23 depicts various timing diagrams, in accordance with various embodiments of the disclosure;

FIG. 24 is a plot of current and voltage over time, according to various embodiments of the disclosure;

FIG. 25 is a flowchart depicting another method, in accordance with various embodiments of the disclosure; and

FIG. 26 depicts a device including a curve tracer, according to various embodiments of the disclosure.

### DETAILED DESCRIPTION

In the following detailed description, reference is made to the accompanying drawings, which form a part hereof, and in which are shown, by way of illustration, specific embodiments of the disclosure that may be practiced. These embodiments are described in sufficient detail to enable those of ordinary skill in the art to practice the invention, and it is to be understood that other embodiments may be utilized, and that structural, logical, and electrical changes may be made within the scope of the disclosure.

In this description, specific implementations are shown and described only as examples and should not be construed as the only way to implement the present disclosure unless specified otherwise herein. It will be readily apparent to one of ordinary skill in the art that the various embodiments of the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Referring in general to the following description and accompanying drawings. various embodiments of the present disclosure are illustrated to show their structure and method of operation. Common elements of the illustrated embodiments may be designated with similar reference numerals. It should be understood that the figures presented are not meant to be illustrative of actual views of any particular portion of the actual structure or method, but are merely idealized representations employed to more clearly and fully depict the present invention defined by the claims below.

It should be appreciated and understood that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the embodiments of the present disclosure may be implemented on any number of data signals including a single data signal.

It should be further appreciated and understood that the various illustrative logical blocks, modules, circuits, and algorithm acts described in connection with embodiments disclosed herein may be implemented as electronic hardware, computer software, or combinations of both. To clearly illustrate this interchangeability of hardware and software, various illustrative components, blocks, modules, circuits, and acts are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the disclosure described herein.

The various illustrative logical blocks, modules, and circuits described in connection with the embodiments disclosed herein may be implemented or performed with a general-purpose processor, a special-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the general-processor may be any conventional processor, controller, microcontroller, or state machine or combination of such elements. A general-purpose processor may be considered a special-purpose processor while the general-purpose processor executes instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration.

When executed as firmware or software, the instructions for performing the processes described herein may be stored on a computer-readable medium. A computer-readable medium includes, but is not limited to, non-transitory storage media, such as magnetic and optical storage devices such as disk drives, magnetic tape, CDs (compact disks), DVDs (digital versatile discs or digital video discs), and semiconductor devices such as RAM, DRAM, ROM, EPROM, Flash memory or other volatile or non-volatile storage means.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

Assessing the health of a PV system is an important part of ensuring that the PV system is functioning properly. An assessment may be a first step in determining what, if any, action must be taken to improve the performance of the PV system. A current-voltage (I-V) curve tracer is used to assess the health of PV systems, but there are various challenges when using an I-V curve tracer to assess PV system health.

One challenge may be heat generated by the I-V curve tracer, such as heat generated from a resistor. This heat may cause the I-V curve tracer to power down, limiting the runtime of the I-V curve tracer, which may need to run continuously in hot environments. Another challenge associated with I-V curve tracers may be accurately measuring high-efficiency (HE) PV modules, which may create an initial high current (“in-rush current” or “in-rush current transient”) that may damage I-V curve tracers or distorts measurements. Yet another challenge associated with I-V curve tracers may be that the voltage time-rate-of-change (dV/dt) during an I-V sweep can cause measurement results that are different from what would be obtained from a “steady-state” measurement (e.g., a static or slow changing resistive load) at any given point on the I-V curve. Yet another challenge associated with I-V curve tracers may be their implementation with module-level electronics (“MLE” or “MLPE”), which may power off during an I-V sweep, thereby disrupting measurements of I-V curve tracers. Yet another challenge with I-V curve tracers is that energy captured during a measurement may be dissipated as heat which can accumulate with repeated measurements. Additionally, some I-V curve tracers can only be used with systems that produce a relatively low amount of power. As will be apparent, these are only some of the challenges that may be present when using I-V curve tracers to assess a PV system.

Aspects of the present disclosure address at least some of these challenges. For example, in some embodiments, an I-V curve tracer includes a switch-mode power converter (SMPC) circuit and a storage capacitor. This configuration may result in various technical advantages. In certain embodiments, an I-V curve tracer disclosed herein can adjust its sweep rate while also not dissipating significant energy during an I-V sweep. By doing so, the I-V curve tracer may reduce the heat that is generated, thereby enabling the I-V curve tracer to operate continuously and in hot environments. Such an I-V curve tracer may, in some embodiments, sweep slow enough to avoid errors cause by the capacitance of HE modules but fast enough to avoid errors caused by solar ramping, thereby improving the overall accuracy of the I-V curve tracer. Yet still, given their configurations, I-V curve tracers disclosed herein may handle relatively higher power PV systems than previous I-V curve tracers. Yet still, in some embodiments, an I-V curve tracer disclosed herein may accurately measure HE modules by using one of a plurality of techniques, including, for example, an SMPC circuit or an in-rush shunt circuit. Yet still, in some embodiments, an I-V curve tracer disclosed herein may accurately measure a PV system that includes MLE devices by efficiently adjusting the power-on and power-off behavior of such devices, such as measuring at least parts of an I-V curve. Other technical improvements provided by aspects of the present disclosure are likewise possible, as would be understood by those having skill in the art.

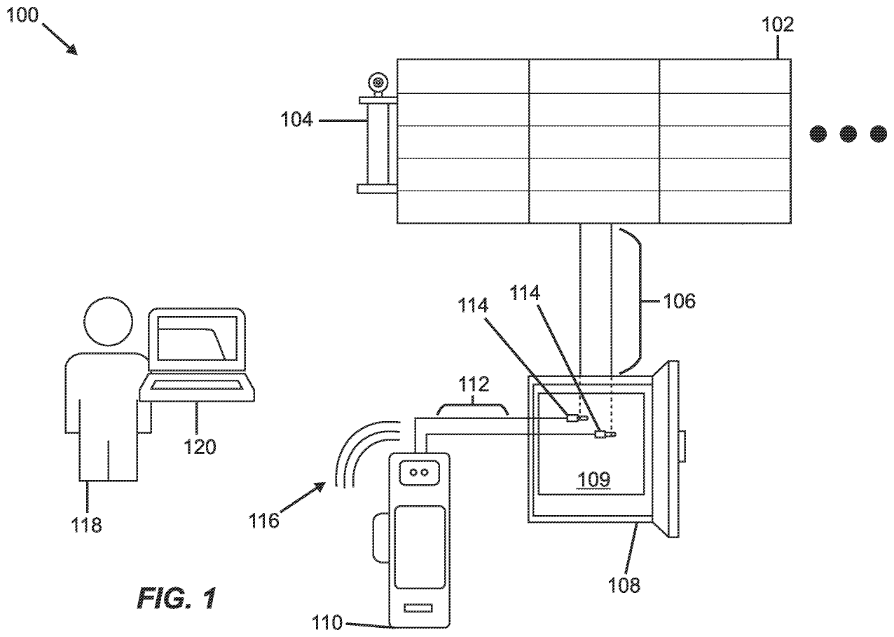

FIG. 1 illustrates an example system 100 in which aspects of the present disclosure may be implemented. In the example shown, the system 100 includes a PV circuit 102 which may include a PV module or array of modules, a measurement device 104, connectors 106, a combiner box 108, combiner box circuitry 109, an I-V curve tracer 110, connectors 112, clips 114, network (which may be physical or WiFi or similar) 116, user 118, and computing device 120.

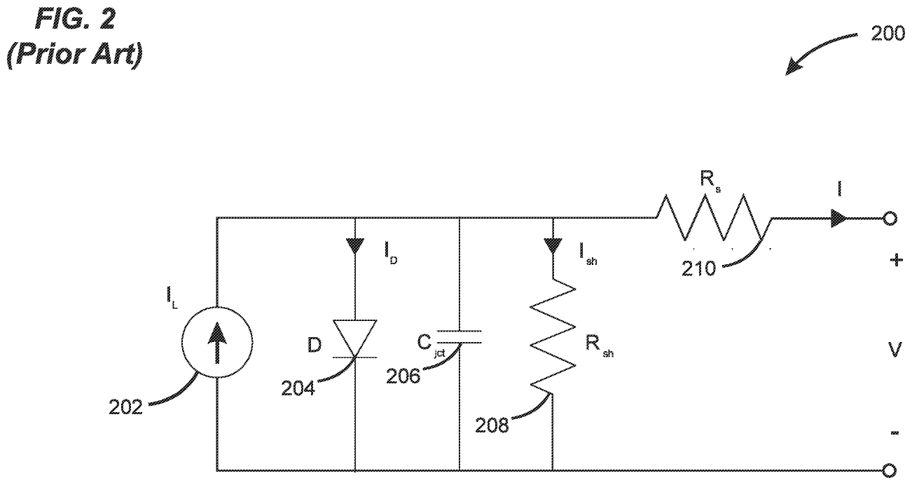

The PV circuit 102 may include one or more PV cells that are part of a PV module, such as the PV cell 200 of FIG. 2, and the PV circuit may be connected to a plurality of PV modules. The performance of the PV circuit 102, and any PV modules connected thereto, may be assessed by the user 118 using components depicted in the system 100. Examples of such assessments, and how they are performed, are described further herein.

The measurement device 104 may be an instrument that measures one or more properties associated with the PV circuit 102. For example, the measurement device 104 may measure the one or more properties associated with the PV circuit 102 when the PV circuit 102 is a PV circuit under test. For example, the measurement device 104 may measure one or more of irradiance, module temperature, or array tilt. In some embodiments, the measurement device 104 is attached to the PV circuit 102, and the measurement device 104 may include external sensor devices coupled to different parts of the PV circuit 102 or PV module that are used to collect sensor data associated with the PV circuit 102. Furthermore, based on the collected sensor data, the measurement device 104 may determine the one or more properties associated with the PV circuit 102. The measurement device 104 may be communicatively coupled to the I-V curve tracer 110, and the measurement device 104 may provide measurements associated with the PV circuit 102 to the I-V curve tracer 110 via a wired or wireless connection. The I-V curve tracer 110 may then use these measurements as part of generating an I-V curve trace. In some embodiments, the measurement device 104 and the I-V curve tracer 110 are communicatively coupled with the network 116.

The connectors 106 may electrically couple the PV circuit 102 with the combiner box 108. The connectors 106 may include one or more of leads, wires, cables, harnesses, and other material used to electrically couple the PV circuit 102 with the combiner box 108.

The combiner box 108 may be electrically coupled to a PV circuit 102 which may include a plurality of PV modules. For example, the combiner box 108 may include combiner box circuitry 109 which receives, via the connectors 106, a current/voltage from the PV circuit 102. Furthermore, the combiner box circuitry 109 may receive an electrical connection from the I-V curve tracer 110. As such, the combiner box circuitry 109 may electrically couple the PV circuit 102 with the I-V curve tracer 110.

The I-V curve tracer 110 is a device that can be used to test and assess the performance of the PV circuit 102. Example embodiments of the I-V curve tracer 110 are described herein. As shown, the I-V curve tracer 110 may be electrically coupled, via for example the connectors 112 and the clips 114 to the combiner box circuitry 109. Via the combiner box circuitry 109, the I-V curve tracer may be electrically coupled to the PV circuit 102. In some embodiments, the I-V curve tracer may be electrically connected directly to the PV circuit 102 without using the combiner box 108.

In some embodiments, the I-V curve tracer 110 is communicatively coupled with the measurement device 104 and the computing device 120. In some embodiments, the I-V curve tracer 110 may form the network 116, and the I-V curve tracer 110, measurement device 104, and computing device 120 may be communicatively coupled via the network 116. In some embodiments, the I-V curve tracer 110 is a hotspot that generates the network 116.

The connectors 112 may electrically couple the I-V curve tracer 110 with the combiner box 108. The connectors 112 may include one or more of leads, wires, cables, harnesses, the clips 114, and other material used to electrically couple the PV circuit 102 with the combiner box 108.

The network 116 may be a wireless or wired or optical or other communication network. In some embodiments, the network 116 is a Wi-Fi network generated by the I-V curve tracer 110. In some embodiments, the network 116 may implement a different network protocol, such as Bluetooth.

The user 118 may be a person that uses components of the system 100 to assess the PV circuit 102. In some embodiments, the user 118 is a technician or engineer. In some embodiments, the user 118 is maintaining or commissioning the PV circuit 102.

The computing device 120 may be one or more of a laptop, tablet, mobile phone, or other computing device. The computing device 120 may include a processor and a display. In some embodiments, the processor is configured to present a real-time progression of at least part of an IV curve on the display. For example, the computing device 120 may include a software program for assessing the PV circuit 102. Based on data received from the I-V curve tracer 110, the computing device 120 may generate and display data, such as a real-time test progression of at least part of an I-V curve associated with the PV circuit 102. In some embodiments, the software application may include features for editing an operating parameter of the I-V curve tracer 110.

The system 100 may include more or fewer components that those depicted in the example of FIG. 1. For example, the PV circuit 102 may be a PV circuit that includes one PV module or multiple PV modules wired in series or parallel or both. Certain embodiments of some of the components described in the system 100 are described further herein.

An electrical model of a PV cell 200 is shown in FIG. 2. When illuminated by the sun, a current source 202 may produce a photo-current I_{L}. Without a load, current I_{L} flows primarily into a diode D 204 (a parasitic shunt resistance Rₛₕ 208 is large and a parasitic series resistance Rₛ 210 is small) so I_{D} is approximately equal to I_{L}, and a voltage V is substantially equal to an open circuit voltage (“Voc”). When a short circuit is connected to PV cell 200, a steady-state current I is substantially equal to a short circuit current (“Isc”). PV cell 200 may also have a capacitance C_{jct} 206 associated therewith.

As will be appreciated by a person having ordinary skill in the art. PV modules may include a number (e.g., many) cells in series, and sometimes may have cell-strings in parallel as well. A PV string or array may include a series and/or parallel combination of PV modules. Cells, modules, strings, and arrays (individually or collectively referred to as “PV circuits”) have electrical characteristics, such as current-voltage (“I-V”) curves. I-V curves are definitive indicators of the performance and integrity of solar modules and may be used to detect even subtle degradations of the solar modules within a PV system. A load applied to a PV circuit under irradiance of the sun may result in a voltage and current combination on the I-V curve of the PV circuit. A static resistive load R applied to a PV circuit may result in a current and voltage where I=V/R. An I-V curve tracer may measure or “sweep” an I-V curve by varying a load applied to the PV circuit. An I-V curve is sometimes described as being “swept” from 0 volts to Voc, from Voc to 0 volts, from 0 amps to Isc, from Isc to 0 amps, from Voc to Isc, or from Isc to Voc. Any of these sweeps can yield data for an I-V curve. I-V curve measurements are disclosed, for example, by Warner et al. in U.S. Pat. No. 4,456,880, titled “I-V Curve Tracer Employing Parametric Sampling.”

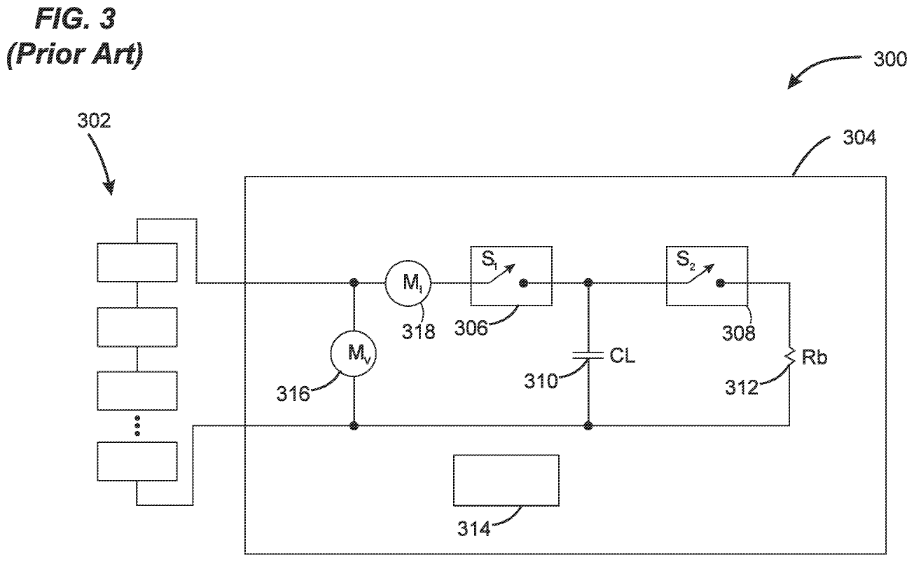

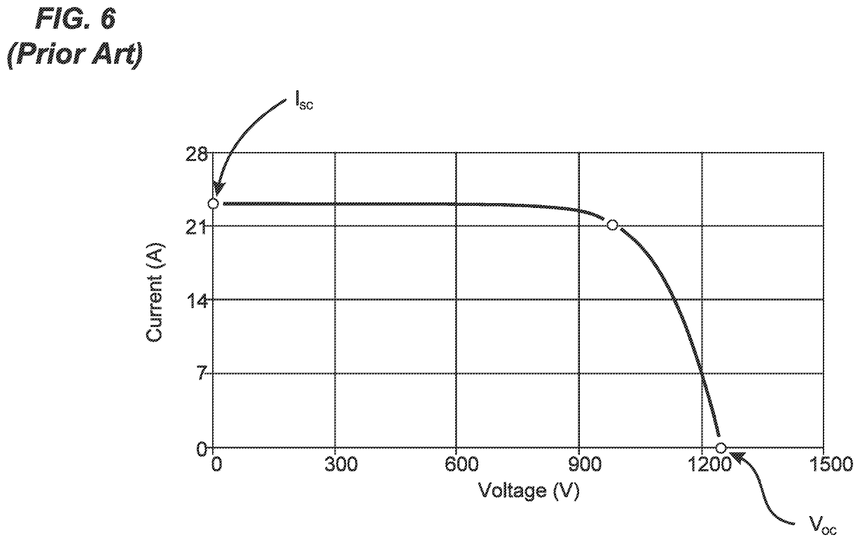

Some I-V curve tracers use a capacitive load CL (also referred to herein as a “Load Capacitor”), as shown in a device 300 of FIG. 3, which includes a PV circuit 302 and a curve tracer 304. A curve tracer controller 314 may be configured to control other elements of the curve tracer 304, such as the switch S1 306 and the switch S2 308. A capacitive load, which may be the capacitor CL 310, may include a single capacitor or multiple capacitors connected in series and/or parallel combinations. A capacitive load may include one or more capacitors that may be switched in or out by the Curve Tracer Controller to achieve a variety of different Load Capacitor values depending on the PV Circuit under test or desired sweep speed (or desired sweep time). The Load Capacitor must be large enough to store the energy accumulated during the I-V Sweep. The stored energy increases as the voltage and sweep time increase. The sweep time increases as the current decreases and as the capacitance increases. For example, when sweeping I-V Curves of a PV Circuit that has a Voc of 1500V and an Isc of 10-30A, and when the desired sweep time is 200 ms or more, a Load Capacitor may be 850 uF to 3400 uF or more and must be rated for the maximum voltage of 1500V. Curve tracer 304 may operate via connecting PV circuit 302 through a switch 306 (e.g., a software controlled electronic switch, such as a transistor) S1 to a capacitor CL 310 that is initially fully discharged to have an initial capacitor voltage of zero volts. Current from PV circuit 302 then charges capacitor CL 310 until the voltage of capacitor CL 310 is substantially equal to the open-circuit voltage of PV circuit 302. Curve tracer 304 measures the current (I) and voltage (V) at multiple points along the way as the capacitor CL charges using current sense element M_{I} 318 (e.g., a sense resistor, sense amplifier, and Analog to Digital Converter (“ADC”)) and voltage sense element M_{V} 316 (e.g., a voltage divider, sense amplifier, and ADC). Current and voltage are typically measured simultaneously. There is typically a period of time between subsequent samples (the sample interval delay). This may result in a characteristic I-V curve as shown in FIG. 6. At the end of the I-V sweep, switch S1 306 may be opened and the energy stored in capacitor CL 310 may be dissipated during the bleed or bleeding mode. This may be done, for example, with a resistive bleeder element Rb 312 (“Resistive Bleeder”) (e.g., a power resistor). For example, a switch S2 308 may be closed and energy flows from capacitor CL 310 to resistive bleeder element Rb 312.

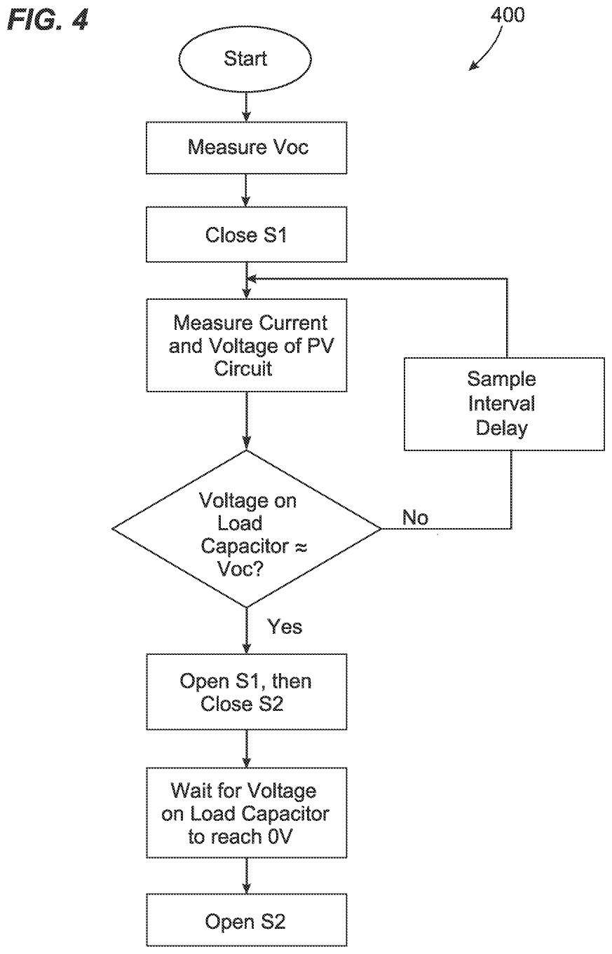

As an example, a typical algorithm for measuring an I-V curve with a capacitive load curve tracer (e.g., curve tracer 304) is shown in a flowchart 400 of FIG. 4.

Other curve tracers use switched resistive loads or active loads (e.g., a transistor) to measure various points on an I-C curve. These kinds of loads may dissipate energy during the I-V sweep in these devices. Some curve tracers pulse (e.g., for 2 ms) the resistive or active load to minimize heat dissipation. The current and voltage may be measured during the pulse.

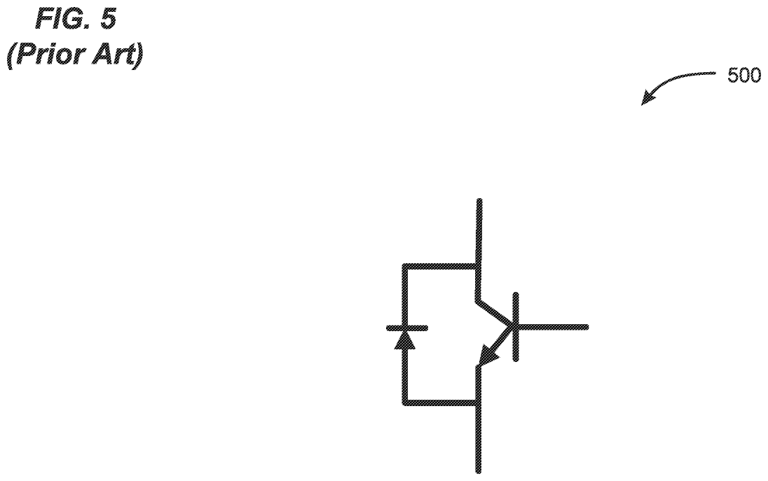

FIG. 5 illustrates a diagram of an example switch 500. The switch 500 is an example of a circuit implementation of a switch that may be used in the C'uk converters in FIGS. 3, 8, and 12. In the switch 500, a floating drive output may be galvanically isolated from the control input. In some embodiments, one or more of the switches described herein may be implemented using the design of the switch 500.

### Limitations—Heat Dissipation

For safety reasons, a resistive bleeder element is generally mounted inside an enclosure (e.g., the case of a product). This may isolate a user from any internal high voltages or high temperatures. Heat from the resistive bleeder element may accumulate inside an I-V curve tracer box causing the device to eventually reach a temperature that when exceeded causes the curve tracer to shut down (e.g., to protect itself). This may limit the run time or sweep-to-sweep time of the I-V curve tracer. Often it is desired to use I-V curve tracers continuously, all day long and in hot environments (e.g., during the commissioning of a large utility scale PV plant in the desert and in which each PV string is measured). It may be desirable to minimize the amount of energy dissipated inside the enclosure of the curve tracer so that sweep-to-sweep time can be short and continuous runtime can be long.

One approach is to mount a resistive bleeder element outside of the enclosure, but then wires must pass out of the enclosure. It may be desirable to minimize the number of wires or electrically conductive material that exits the enclosure to minimize the risk of exposure of high voltage to a user, especially in the event that there is a fault inside the enclosure (e.g., a wire breaks loose inside the enclosure and shorts to other wires or metal, eventually finding its way to the outside of the enclosure).

Another approach is to mount a resistive bleeder element to a heat sink, wherein part of the heat sink is inside an enclosure and part of the heat sink is outside of the enclosure. Heat sinks are often conductive metal, so this configuration may have the same downside as the configuration including wires exiting the enclosure (i.e., as mentioned above) and potentially exposing a user to high voltage. A heat sink may be made of a material that is highly thermally conductive, but not electrically conductive such as ceramics, however, this can add cost and may be fragile. A fan could be included that actively cools a bleeder element and/or heatsink, however, this also adds cost, and furthermore reduces battery life (i.e., to run the fan) and has moving parts that may fail in a dusty environment such as is common for curve tracers. In addition, power to drive such a fan would typically be via wires that, if exiting the enclosure (e.g., product case), may be at hazardous voltages.

### Limitations—In Rush Current

PV modules produce DC current and may also have AC or dynamic characteristics, chiefly from PV cell capacitance (e.g., sec Cjct in FIG. 2), that come into play when an operating point changes rapidly. In addition to a modest amount of parallel plate-type junction capacitance there exists a diffusion capacitance associated with the large amount of charge that is stored in the forward-biased junctions of the PV cells (i.e., the forward-biased diodes of each cell). Diffusion capacitance increases with cell voltage and with irradiance (i.e., photo-current), and may also increase rapidly with cell efficiency (i.e., the efficiency with which a PV cell converts light per area to electrical power). High efficiency (“HE”) modules are made up of HE cells. For example, the SunPower SPR-X22 and REC 400AA have efficiencies of around 22%. The magnitude of diffusion capacitance of a PV circuit can reach the tens of microfarads or higher range for HE modules. At the instant the I-V sweep starts to short the PV circuit, the free charge in the cells may surge into an associated curve tracer, potentially causing a current overload error or damage to the curve tracer circuit. Many I-V curve tracers are not able to tolerate this in-rush current associated with HE modules and are either damaged, produce errors, or are not able to make measurements. Some curve tracers will use a pulsed load, which may cause the in-rush current transient to occur with every pulse involving a large change in current in the PV circuit.

It may be desirable for an I-V curve tracer to measure HE modules accurately and successfully.

Normally when an I-V curve of a string is to be measured, the string is first disconnected from any inverter that it may otherwise be normally connected to. However. if a user makes a mistake and attempts to measure an I-V curve of a PV string that is connected to the input of an inverter there can be a very high in-rush current into an associated I-V curve tracer. PV inverters typically have a large input capacitance orders of magnitude greater than the capacitance of the PV modules, which has been observed to cause a very large in-rush current. This large in-rush current may damage the I-V curve tracer, cause to the I-V curve tracer to produce errors, and/or cause the I-V curve tracer to otherwise malfunction such that measurements may not be made. Protective circuits may be needed to protect measurement circuitry (i.e., of the I-V curve tracer) when this occurs. However, it can be difficult to differentiate between the in-rush current that is due to a mistaken inverter connection, where it is desirable for protection circuitry to abort the measurement, versus a string of HE modules, where the measurement should still be made.

It may be desirable for an I-V curve tracer to measure HE modules accurately and successfully while at the same time preventing damage from an inadvertent measurement if connected to an inverter.

### Limitations—Accuracy of Measuring High Efficiency Modules

Another aspect of HE modules that presents a challenge, is that in addition to large in-rush current, the voltage time-rate-of-change (dV/dt) during an I-V sweep can cause measurement results that are different from what would be obtained from a “steady state” measurement (e.g., a static or slow changing resistive load) at any given point on the I-V curve. When HE modules are swept from Voc to Isc or from Isc to Voc in order to generate an I-V curve there may be an error in the measured shape of the resulting I-V curve due to the rapidly changing voltage. The error in the shape of the I-V curve depends on how quickly the I-V curve is swept. The faster the sweep, the greater the error. Also, the higher the efficiency of the cells, the greater the error. This is due to stored charge in the forward-biased junctions of the PV cells, and is roughly analogous to a non-linear capacitance in each PV junction. To minimize the measurement error with HE modules, it may be necessary to sweep the I-V curve slow enough that this effect is small. However, some I-V curve tracers are not able to sweep slow enough or adjust their sweep time in a flexible way. For example, the sweep time for a capacitive load I-V curve tracer is a function of the load capacitor, and the current and voltage of the PV circuit being measured. Other curve tracers are not able to sweep slowly because they use active or resistive loads that dissipate energy during the I-V sweep. Other curve tracers pulse an active or resistive load to minimize heat dissipation in the load element, but the pulse itself is very fast (e.g., 2 ms) and the dynamic response of the HE modules associated with the capacitance can make it challenging or impossible to measure.

An I-V curve tracer that can arbitrarily adjust its sweep rate while also not dissipating significant energy during the I-V sweep may be desirable.

### Limitations—Module Level Electronics

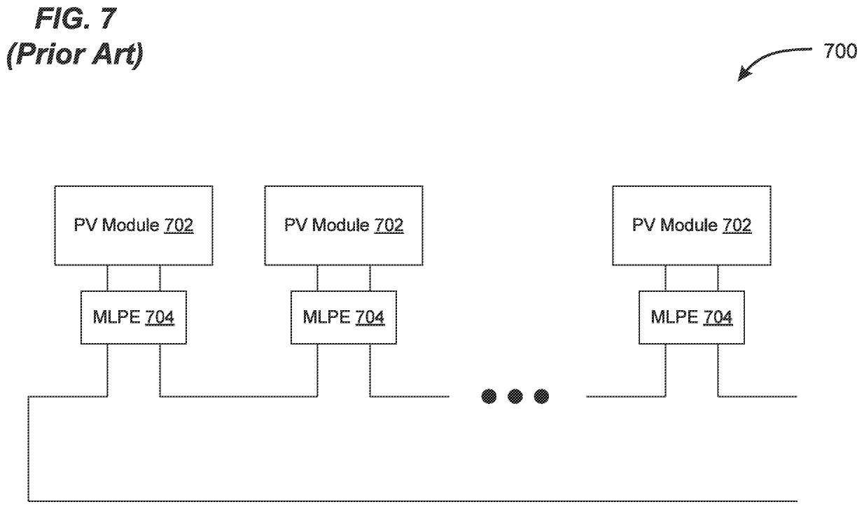

FIG. 7 illustrates a schematic block diagram of a PV system 700 that includes a plurality of PV modules 702 of a PV circuit. Each of the PV modules is electrically coupled with a module-level electronic device (“MLE”) or module-level power electronic device (“MLPE”), which are depicted as a plurality of MLPE 704 devices. An MLPE 704 may include components that improve the performance of an associated PV module 702, thereby improving the performance of the PV circuit more generally. In some embodiments, an MLPE 704 may include a microinverter or DC power optimizer. In some embodiments, an MLPE 704 may include performance or diagnostic monitoring features. In some embodiments, an MLPE 704 may have a rapid shutdown device, which may rapidly reduce, or stop, the current or voltage coming from an associated PV module 702.

When attempting to sweep a PV module 702 or string of modules in which the modules are equipped with an MLPE 704, a sweep starting from short-circuit (and thus zero voltage) may cause the MLPE 704 electronics to turn off, which typically also disconnects the module from the string. There may not be enough voltage for the electronics to operate and thus the electronics may turn off. The electronics may not turn on again for several seconds and the I-V measurements may be inaccurate.

It may be desirable for an I-V curve tracer to be able to measure at least partial I-V curves of modules and strings of modules with MLPE 704.

### Limitations—Existing Switch-mode Approaches

In some instances, a resistive element may be used as the load for the SMPC. This means that the energy transferred from the PV Circuit by the SMPC must be dissipated as heat. What is needed is a way to sweep the IV curve with a SMPC without having to dissipate the energy as heat. While some curve tracers for prior art systems have relatively low power handing capabilities, field measurements of utility-scale PV systems require the ability to handle higher levels of power. For example, PV strings in utility-scale systems may have voltage levels up to 1500V and may have currents of 30 Amps or more. What is needed is an SMPC I-V Curve tracer with much higher power handling capabilities of, for example, 15 kW to 45 kW or more.

### In-Rush Shunt

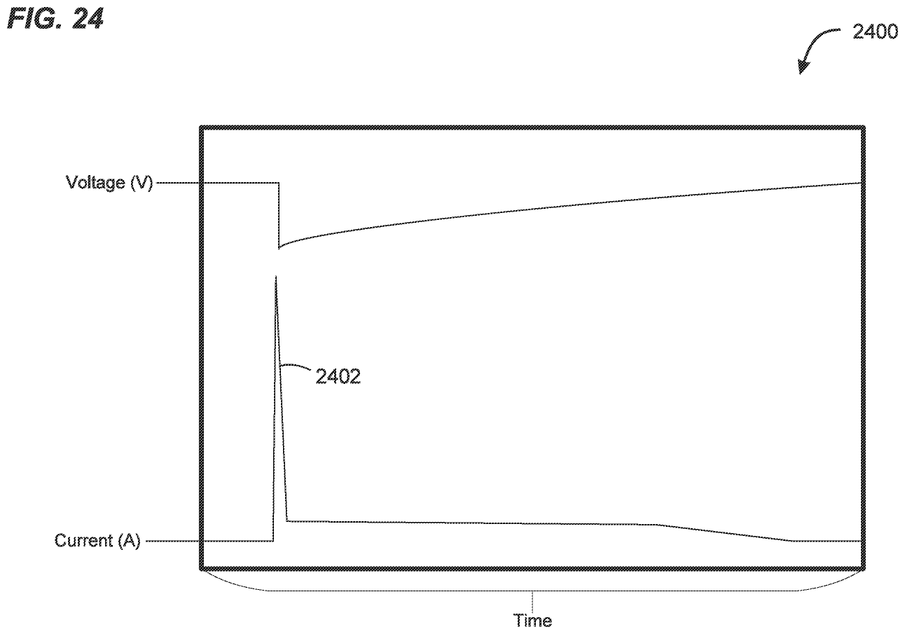

As discussed above, HE modules have high capacitance that has been observed to result in a large in-rush current when an array is shorted at the beginning of an I-V sweep from Isc to Voc or during pulsed load measurements. This in-rush current can be, for example, on the order of 400 Amps for a nominal 30A Isc array, and can last, for example, around 100-600 us. See, for example, the in-rush current pulse in FIG. 24.

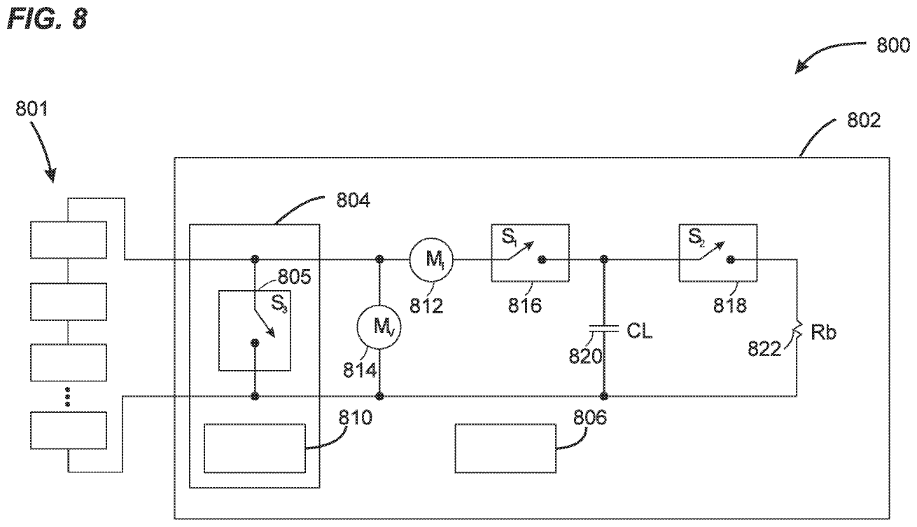

Damage to internal electronic components that are not rated for this kind of in-rush current can occur. But components that are rated for this high current are expensive and generally bulky. With reference to FIG. 8, a device 800 includes a PV circuit 801 and a curve tracer 802. In some embodiments of the present disclosure, curve tracer 802 includes an in-rush shunt circuit (“shunt”) 804 configured to clamp or shunt the in-rush current away from an associated measurement circuits, preventing the in-rush current from propagating into other parts of curve tracer 802. This configuration may allow other internal components to have comparatively low current ratings and therefore save cost.

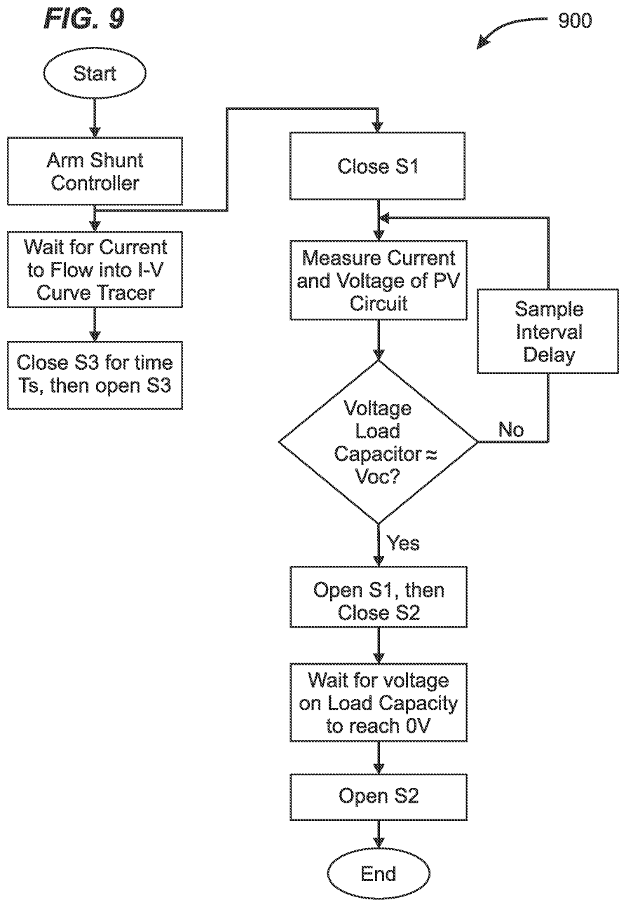

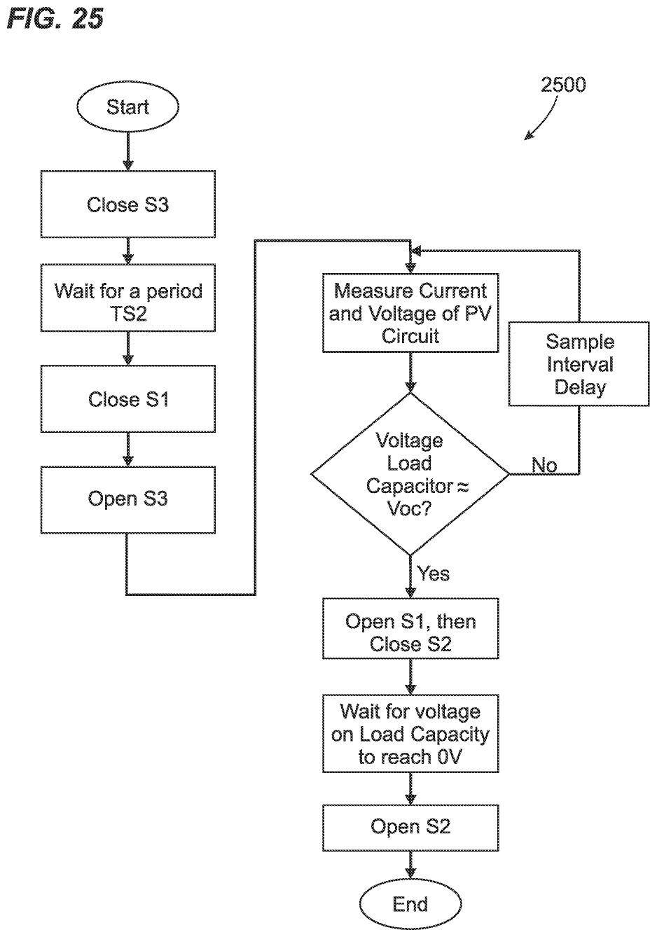

Shunt 804 may include a current sense circuit (not shown) that detects an increase in current into the curve tracer 802 that indicates the beginning of an I-V sweep or it may detect a high in-rush current. This current sense circuit then causes the shunt controller 810 to turn on an electronic switch S3 805 (e.g., an Insulated Gate Bipolar Transistor (“IGBT”) or other high-current, high voltage switching devices) that momentarily diverts the current either into a short circuit as shown in FIG. 8 or, alternatively, into a load such as a resistor or capacitor. Switch S3 805 may be controlled by a shunt controller 810. After the in-rush current has been shunted for a certain amount of time Ts (e.g. 600 us) shunt controller 810 may open switch S3 805, releasing the circuit. The normal I-V curve sweep may then continue (starting with the short circuit). For example, the curve tracer controller 806 first enables or arms the shunt controller which then starts monitoring the current. Then, the curve tracer controller 806 closes switch S1 816 starting the flow of current from the PV circuit 801 into load capacitor CL 820 which is initially at zero volts and subsequently starts charging up. When the shunt controller 810 detects current flowing, it closes switch S3 805 for a period of time Ts, then opens S3 805. The load capacitor CL 820 continues to charge up to Voc while current and voltage are measured at multiple points on the I-V curve. When the I-V Curve sweep is complete, the curve tracer controller 806 opens switch S1 816, and then S2 818 is closed to bleed down the voltage on load capacitor CL 820, then S2 818 is opened. In another example, S3 805 is closed for a period of time Ts, then opened. After S3 805 is opened, then a curve tracer controller 806 may close switch S1 816 to start the I-V sweep. Current from PV circuit 801 may then flow into load capacitor CL 820 which is initially at zero volts and subsequently charges up to Voc while current and voltage are measured at multiple points on the I-V curve. At the end of the sweep, switch S1 816 is opened and switch S2 818 is closed to discharge the stored energy in load capacitor CL 820 via resistive bleeder Rb 822. This method is shown in a flowchart 900 of FIG. 9. In another example, switch S3 805 may be closed, starting current flowing from the PV circuit 801 into the in-rush shunt, then switch S1 816 is closed, causing current from the PV circuit 801 to also flow into the load capacitor CL 820 which is initially at zero volts and subsequently starts charging up. Then, switch S3 805 is opened either after a pre-determined amount of time (e.g. for a period TS2), or when the in-rush current transient has been fully or partially shunted. The load capacitor CL 820 continues to charge up to Voc (or close to Voc) while the current and voltage of the PV circuit 801 are measured at multiple points on the I-V curve. Then, when the I-V curve is complete, S1 816 is opened and S2 818 is closed to bleed down the voltage on load capacitor CL 820, then S2 818 is opened. Current and voltage of the PV circuit 801 may be measured during the period of time when switch S3 805 is closed as well as during the period when switch S1 816 is closed as well as any other time when the I-V curve tracer is in operation. This method is shown in a flowchart 2500 of FIG. 25.

### Capacitive Load Piecewise Sweep

As discussed above, when attempting to sweep a PV circuit with a capacitive load curve tracer in which modules are equipped with “optimizers” or “rapid shut-down” electronics (“module level electronics” or “MLE”), a sweep starting from short-circuit (and thus zero voltage) may causes the MLE to turn off, which typically also disconnects the module from an associated curve tracer. When this happens a typical curve tracer may not be able to make the I-V measurement. But the MLE typically do not shut off immediately when shorted. The MLE may be able to stay on and running for a period of time (e.g., 10-100 ms) before powering off. During this time, part of the I-V curve can be swept even if the sweep starts at short circuit. A certain amount of charge is transferred from the PV circuit into the load capacitor during this time. If the curve tracer load is removed (i.e., switch S1 returns to open), the MLE will typically power back on after a period of time (e.g., 1-10 seconds). In some embodiments, a controller is configured to sweep a first part of the I-V curve from an open circuit voltage to a non-zero voltage lower than the open circuit voltage. In some embodiments, the controller is configured to sweep a first part of the IV curve from a first voltage that is lower than the open circuit voltage to a second voltage that is lower than the first voltage. In some embodiments a controller is configured to sweep a first part of the I-V curve from zero volts to a higher voltage that is lower than the open circuit voltage. In some embodiments, the controller is configured to sweep a first part of the IV curve from a first voltage that is higher than zero volts to a second voltage that is higher than the first voltage.

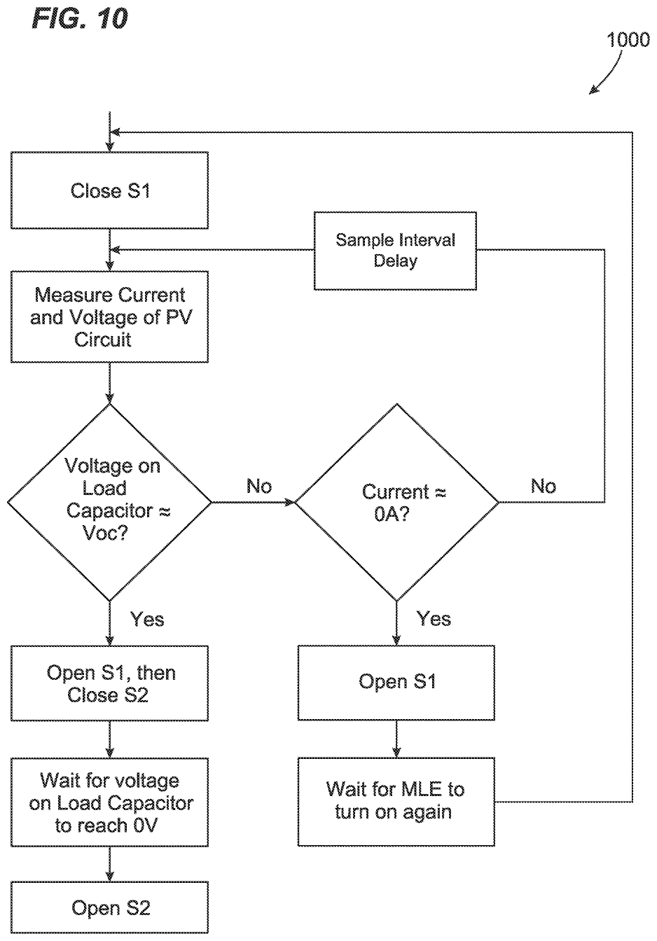

In one embodiment, an I-V curve is swept, and charge flows from PV circuit to load capacitor CL charging it up to a certain voltage less than Voc, until the MLE turns off and the current stops flowing. The stored charge may be left in load capacitor CL (not removed with a bleeder circuit like it typically would after an I-V sweep). Then, when the MLE powers on again, another sweep is made. Since load capacitor CL is already charged to a voltage higher than zero, the I-V sweep starts at that voltage and continues to increase in voltage as more charge goes into load capacitor CL. This may continue until the MLE turns off again. And, again, the charge is left in load capacitor CL, not bled down. This process may repeat until the voltage on load capacitor CL reaches Voc. As a result, a full I-V curve is built up from a sequence of partial I-V curves. This method is shown in a flowchart 1000 of FIG. 10. In one example, the controller is configured to cause a voltage on a load capacitor to reach an open circuit voltage by repeating a connecting-disconnecting cycle having a connecting step and a disconnecting step, wherein the connecting step comprises connecting the load capacitor to a PV circuit under test via a module level electronics (MLE) until the MLE powers off, and the disconnecting step comprises disconnecting the load capacitor from the PV circuit under test until the MLE powers on.

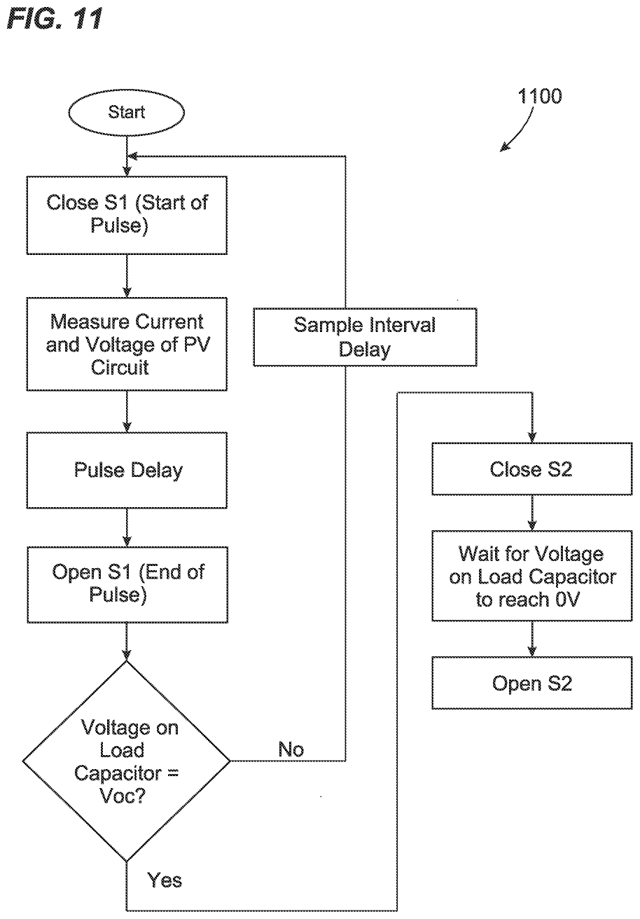

Normally, in an I-V curve sweep, switch S1 (see FIG. 3) is closed for an entire duration of a sweep, and charge flows into load capacitor CL until the voltage on load capacitor CL reaches Voc (or until the MLE powers off as discussed above). In another embodiment, switch S1 is repeatedly pulsed throughout the sweep. During each pulse a small amount or charge flows from PV Circuit 302 into load capacitor CL, charging up the voltage on the load capacitor CL by a small amount. The pulsing may continue until the voltage on load capacitor CL reaches Voc. In some examples. MLE may not turn off in response to a pulsed load (e.g., short circuit) if the pulse is short (e.g., 1-10 ms), and so by repeatedly pulsing the load, the I-V curve may be completed without the MLE powering off. This process is shown in a flowchart 1100 of FIG. 11.

MLE devices may require an activation signal in order to properly operate (e.g., rapid shut down devices). In the embodiments described above when an activation signal is required, this may be supplied by the I-V curve tracer or by a separate device.

### SMPC Bleeder

In various embodiments, during the bleed mode, a resistive element serves the function of bleeding down the voltage on the load capacitors to close to zero volts after an I-V curve sweep is complete. One challenge with resistive elements, as discussed above, is that they dissipate heat, thereby raising the internal temperature within a curve tracer. Various embodiments may minimize the amount of heat that is accumulated inside an enclosure. In one embodiment, during the bleed mode, the bleeder may include a circuit that transfers the energy stored in load capacitor CL back into a PV circuit where it is dissipated over the large area of the PV modules. An advantage of this approach is that there is minimal heat dissipated inside the enclosure of the curve tracer. Normally a PV circuit is a source of energy (i.e., it converts the sun's energy into electrical energy) and current and power flow out from the PV circuit into an inverter or I-V curve tracer which are loads. The novel SMPC bleeder embodiments reverse this flow of energy (i.e., the PV circuit becomes the load, and the curve tracer becomes the source of power and energy). Power flows backwards into the PV circuit and into diode D in the cell model shown in FIG. 2 where it is dissipated mostly as heat. The PV module(s) may heat up a small amount as they dissipate the energy transferred into them. Since the PV modules have a very large surface area (c.g., relative to a curve tracer bleeder resistor), the PV modules may easily dissipate the energy with minimal temperature rise.

Power may be pushed into a PV circuit in a variety of ways. In various embodiments, a switch-mode power converter (“SMPC”) circuit may be used. An SMPC circuit can be thought of as a way to transfer power or transfer energy from one place to another, with minimal loss or heat dissipation within the SMPC itself. The SMPC circuit can transfer energy from one circuit (e.g., a source) operating at one current and voltage to another circuit (e.g., a load) operating at a different current and voltage as long as the amount of power at any given time coming from the source is the same as that going into the load (neglecting real-world losses and timing in the SMPC circuit). In other words, an ideal SMPC circuit can convert power P at a voltage V1 and current I1 to power P at a different voltage V2 and current I2.

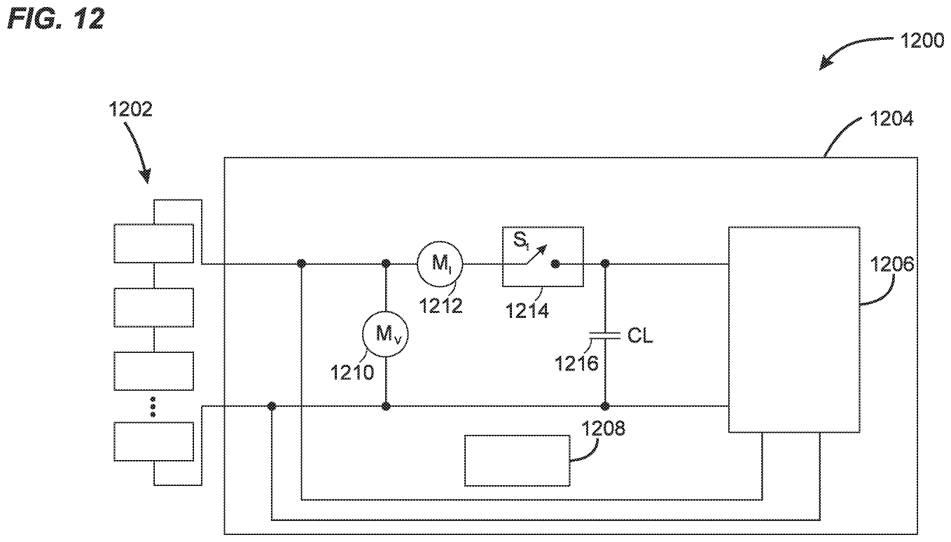

With reference to FIG. 12 that depicts a device 1200 including a PV circuit 1202 and a curve tracer 1204, according to various embodiments, an SMPC bleeder 1206 may be constructed using a SMPC circuit to transfer the energy of the charge stored in a load capacitor CL 1216 into PV circuit 1202. The PV circuit 1202 may be under test. The curve tracer includes a voltage sense element Mv 1210 and a current sense element M_{I}. During a sweep, the curve tracer controller 1208 may close the switch S1 1214 to transfer energy to the load capacitor CL 1216. The SMPC circuit includes a feedback control loop that adjusts the duty cycle of a switch to achieve a certain target current. The design may use an inductor and a SMPC controller may be controlling on output current so that the output voltage may naturally accommodate whatever voltage is needed to force the current into PV circuit 1202.

A curve tracer controller 1208, instead of turning on switch S2 (see FIG. 3), may turn on SMPC bleeder 1206 to remove stored charge (and thus energy) from load capacitor CL. The curve tracer controller 1208 may be coupled to the SMPC circuit of the SMPC bleeder 1206 and to the load capacitor CL 1216. In some embodiments, the curve tracer controller 1208 may perform operations described as being performed by other controllers described herein, such as one or more of the curve tracer controller 314, the curve tracer controller 806, the shunt controller 810, the SMPC bleeder controller 1302, the curve tracer controller 1414, the SMPC controller 1618, the SMPC controller 1702, the SMPC controller 1918, or the curve tracer controller 2110. Furthermore, in some embodiments, other controllers described herein may perform one or more of the operations described as being performed by the curve tracer controller 1208. More generally, an operation described herein as being performed by a first controller may, in some embodiments, be performed by a second, different controller described herein. In some embodiments, the curve tracer controller 1208 is a digital controller. In some embodiments, the curve tracer controller 1208 includes analog circuitry.

The curve tracer controller 1208 may be configured to sweep an IV curve of the PV circuit 1202 in a sweep or sweeping mode, and the curve tracer controller 1208 may be configured to transfer energy from the load capacitor CL 1216 to the PV circuit 1202 in a bleed mode.

For example, in a sweep mode, the switch 1214 may be configured to be in a closed state, which may cause to the load capacitor CL 1216 to be charged. This charging of the load capacitor CL 1216 may transfer energy from the PV circuit 1202 to the load capacitor CL 1216. In some embodiments the curve tracer controller 1208 sweeps the IV curve from the open circuit voltage to zero volts or from zero volts to the open circuit voltage. In some embodiments, the curve tracer controller 1208 sweeps a first part of the IV curve from an open circuit voltage to a non-zero voltage lower than the open circuit voltage. In some embodiments, the curve tracer controller 1208 sweeps a first part of the IV curve from a first voltage that is lower than the open circuit voltage to a second voltage that is lower than the first voltage. In some embodiments, during a sweep of the first part of the IV curve, energy is transferred to the load capacitor CL 1216. Furthermore, in some embodiments, the curve tracer controller 1208 is configured to transfer energy from the load capacitor CL 1216 to the PV circuit 1202 before sweeping a second part of the IV curve. The second part of the IV curve may be different than the first part of the IV curve.

In a bleed mode, the switch 1214 may be configured to be in an open state to discharge the load capacitor CL 1216. Discharging the load capacitor CL 1216 may transfer energy from the load capacitor CL 1216 to the PV circuit 1202. In some embodiments, the curve tracer controller 1208 may control the switch 1214.

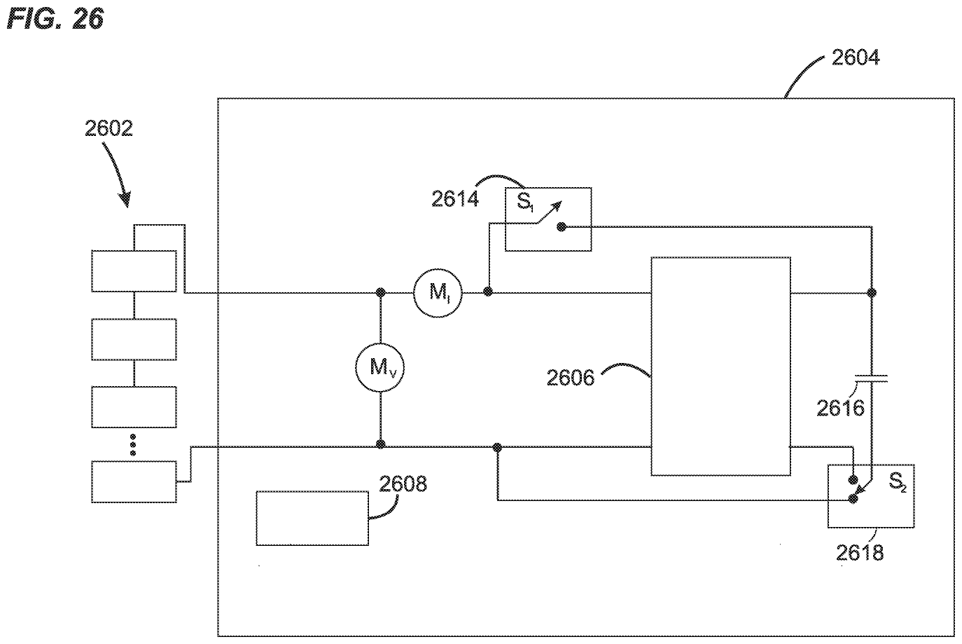

In another embodiment, the curve tracer circuit is configured as shown in FIG. 26, and simplifies the connection of the SMPC bleeder 2606 to the PV circuit 2602. FIG. 26 includes a curve tracer 2604. A first side of load capacitor CL 2616 is connected to a first input on the SMPC bleeder 2606 and switch S1 2614. A second side of load capacitor CL 2616 is connected to a switch S2 2618. For example, in a sweep mode, the switch S2 2618 may be configured as shown in FIG. 26 connecting the second side of load capacitor CL 2616 to one side of the PV circuit 2602. Switch S1 2614 may be configured to be closed, which may cause the load capacitor CL 2616 to be charged. This charging of the load capacitor CL 2616 may transfer energy from the PV circuit 2602 to the load capacitor CL 2616 while Mv and Mi measure the voltage and current of the PV circuit 2602 at multiple points. Then, switch S1 2614 is opened. In the bleed mode, the switch S2 2618 may be switched to the other configuration, connecting the second side of load capacitor CL 2616 to a second input of the SMPC bleeder 2606 to discharge the load capacitor CL 2616. Discharging the load capacitor CL 2616 may transfer energy from the load capacitor CL 2616 to the PV circuit 2602. In some embodiments, the SMPC controller 2608 is configured to control one or more other components of the curve tracer 2604, such as one or more of the switch S1 2614, the switch S2 2618, or the SMPC bleeder 2606.

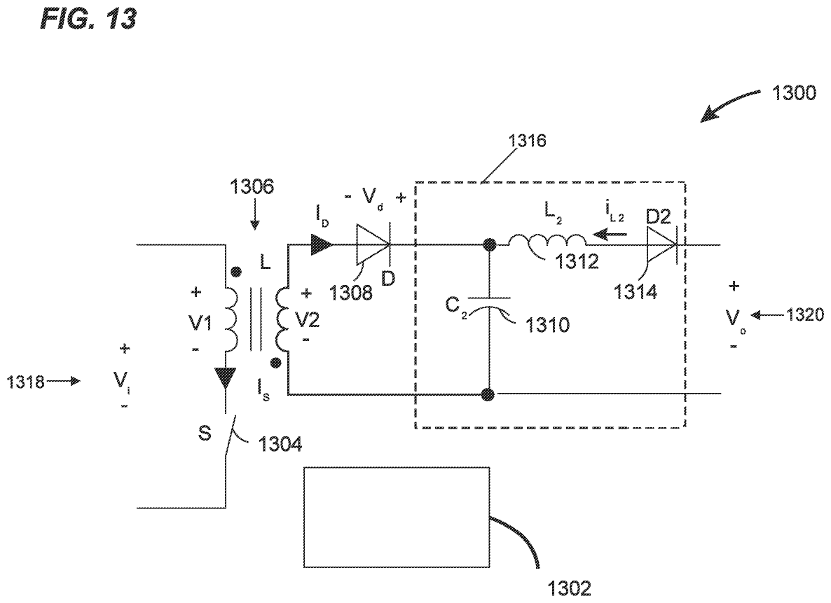

One type of SMPC bleeder circuit 1300 uses a “fly-back” converter as shown in the simplified conceptual schematic of FIG. 13. FIG. 13 includes an input voltage Vi 1318 and an output voltage Vo 1320. In some embodiments, the SMPC bleeder circuit 1300 causes the load capacitor CL 1216 to discharge a current into the PV circuit 1202. An SMPC bleeder controller 1302 switches a switch S 1304 at a comparatively high frequency (e.g., 50-500 kHz). When switch S 1304 is closed, the primary winding of the two-winding inductor (e. g., a transformer) L 1306 is directly connected to an input voltage Vi 1318. The primary current and magnetic flux in two-winding inductor L 1306 increases, storing energy in a two-winding inductor L 1306. The voltage induced in a secondary winding V2 is negative, so a diode D 1308 is reverse-biased (i.e., blocked). When switch S 1304 is opened, the primary current Is stops. Secondary voltage V2 becomes positive, forward-biasing diode D 1308, allowing current to flow from the transformer secondary winding L to the output (e.g., to the PV circuit). In this instantiation of the Flyback topology, control is of the current (and thus energy) in the primary winding. Thus, no output capacitor is needed (unlike with some fly-back converters). Input voltage Vi 1318 may be the voltage on the input (e.g., the load capacitor). SMPC controller 1302 may monitor the input current and voltage and the output current and voltage and repeatedly close and open switch S 1304 with a varying duty cycle in a feedback loop that targets one or more current and voltage setpoints. This type of SMPC Bleeder may be called a “SMPC Bleeder” or “Fly-Back Bleeder.”

In the embodiment depicted in FIG. 13, the SMPC bleeder circuit 1300 includes an optional L-C EMI filter 1316 and an additional diode D2 1314. The optional L-C EMI filter 1316 includes a capacitor 1310 and an inductor 1312. The purpose of D2 1314 is to prevent large surge currents (similar to those of the capacitance of a PV array) from being generated by discharge of C2 during a sweep.

Referring to FIG. 12, after an I-V sweep, load capacitor CL 1216 may be at the Voc of PV circuit 1202. To cause current to flow from the load capacitor CL 1216 back into the PV string the output Vo may be sufficiently higher than the Voc of the PV string. Since the output of the Flyback converter (e.g. FIG. 13, but neglecting the optional EMI filter) is a two-winding inductor L 1306 with stored energy, the inductor will “ring back” with sufficient voltage to push current into PV circuit 1202. As the charge on load capacitor CL 1216 is bleed off into PV circuit 1202, the voltage on load capacitor CL 1216 drops until the load capacitor voltage reaches close to zero volts. At that point any residual charge in load capacitor CL 1216 (and thus residual energy) can easily be bled off with a simple resistor (not shown) of much lower power dissipation than would be the case for a simple resistive (only) bleeder.

### Two Quadrant SMPC Curve Tracer

As discussed above, the existing art of I-V curve tracer architectures most commonly includes a capacitive load, a resistive load, or an active transistor load. With these approaches the load “sees” the same voltage and current as a PV circuit under test. An alternative novel approach to achieve an I-V sweep of a PV circuit is to use a switch-mode power converter (“SMPC”) architecture as a variable load.

As discussed above, an SMPC circuit can be thought of as a way to transfer energy from one place to another. For example, it can transfer energy from a PV circuit to a resistive load. But using a resistive load results in heat dissipation in the I-V curve tracer. The present invention instead uses the SMPC to transfer energy, during the sweep or sweep mode, from a PV circuit into a storage element such as a load capacitor, inductor, battery, spinning mass, etc. Using the storage element enables the present invention to handle powers of 15 kW or more because the sweeping of the I-V curve during the measurement can be de-coupled from the dissipation of the energy in the storage element. The I-V curve sweep can be made quickly (e.g., 200 ms) while the dissipation of the energy in the storage element (the bleeding) can take longer (e.g. 6 seconds). The switching electronics don't need to dissipate much energy and the bleeder circuit can take longer to dissipate the stored energy. The SMPC circuit can transfer energy from a PV circuit operating at one voltage and current into a storage element, such as a storage capacitor, that is at a different voltage and being charged at a different current as long as the amount of power at any given time coming from the PV circuit is the same as that going into the storage element (neglecting “real-world” losses and timing in the SMPC circuit).

In various embodiments of the present disclosure, an I-V curve tracer includes an SMPC circuit that may present an associated PV circuit with an arbitrary load and may vary that load to sweep an I-V curve transferring the energy from the PV circuit to a storage element such as a storage capacitor.

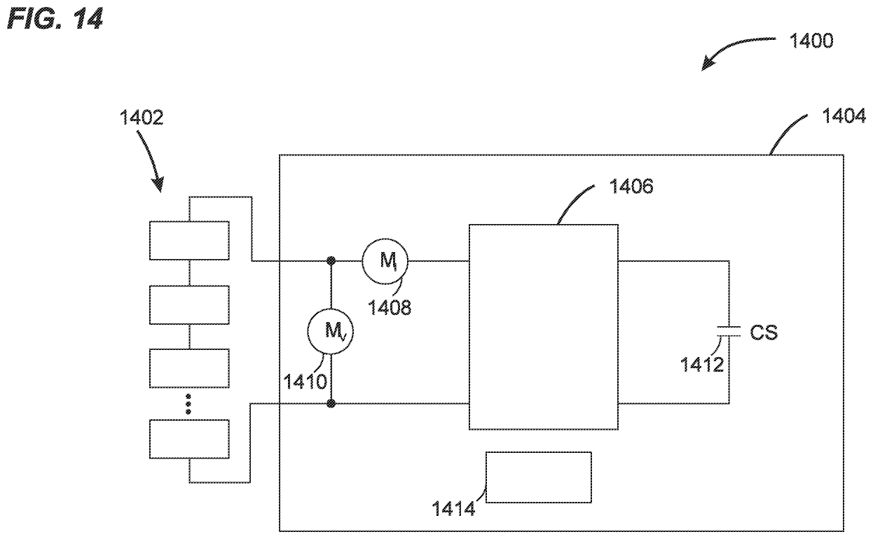

FIG. 14 depicts a system 1400 including a PV circuit 1402 and an SMPC curve tracer 1404 that includes a storage capacitor CS 1412, an SMPC circuit 1406, and a curve tracer controller 1414, which may control other components of the SMPC curve tracer 1404. The SMPC curve tracer 1404 further includes a current sensing element MI 1408, a voltage sensing element Mv 1410, and a storage capacitor CS 1412. The benefits of embodiments that use an SMPC circuit in this way may include one or more of the following:
1. The ability to sweep the I-V curve either from open circuit voltage (Voc) to short circuit current (Isc) or vice-versa in a controlled fashion;
2. Minimal dissipation of energy during the I-V sweep;
3. The ability to transfer energy from the PV circuit to a storage element during the I-V sweep and then reverse the process and push the stored energy from the storage element back into the PV circuit (i.e., rather than dissipating the energy inside the curve tracer with a bleeder resistor) during the bleed mode—similar in concept to the Fly-back Bleeder described above:
4. The ability to arbitrarily control the starting current and/or ending current of the sweep (within the limitations of the PV circuit);
5. The ability to arbitrarily set the starting voltage and/or ending voltage of the sweep (within the limitations of the PV circuit);
6. The ability to arbitrary set the sweep speed and timing from point to point; and/or
7. Prevention of over-current events.

Sweeping from Voc to Isc (or equivalently, Voc to 0 volts or 0 amps to Isc) may allow a curve tracer to eliminate or reduce the in-rush current that occurs with strings of HE modules, because when the sweep starts at Voc there is no current flowing and so there may not be a rapid and potentially large change in current at any time during the sweep. It may also enable the curve tracer to stop the sweep at a voltage higher than zero and before module level electronics (“MLE”), such as power optimizers or rapid shut down devices, turn off.

The ability to arbitrarily control sweep speed and point-to-point timing may have a number of advantages. An SMPC curve tracer 1404 is able to limit the rate-of-change of voltage (dV/dt) from a PV circuit. As discussed above, when dV/dt gets faster, stored charge in the “diodes” of the PV cells (e.g., D in FIG. 2) may cause differences between the swept I-V measurement result compared to a series of slower or “static” (e.g., resistive) I vs V measurements. This may cause error in the measurement of the I-V curve measurement results. By constraining dV/dt to some maximum value (which may be dependent on the Voc of the PV circuit) this source of measurement error may be reduced.

Alternatively, a SMPC curve tracer 1404 may speed up the sweep to minimize “solar ramping” in which changing solar irradiance during an I-V sweep causes errors in the shape of the I-V curve. An SMPC curve tracer 1404 may be able to optimize the sweep speed to balance the two desirable measurement goals of: 1) sweeping slow enough to avoid significant errors caused by the capacitance of the HE modules, and 2) sweeping fast enough to avoid significant errors caused by solar ramping during the I-V sweep.

An SMPC curve tracer 1404 may also change the sample timing during different sections of an I-V curve. For example, an SMPC curve tracer 1404 may sweep the flat and vertical portions of the I-V curve more rapidly while slowing down during the “knee” around the maximum power point (“MPP”). This may lead to higher accuracy in the overall curve. The capacitance of HE modules increases significantly above around 75% of Voc. Therefore, in some situations, it may be preferable to use a faster sweep time at voltages below around 75% of Voc while a slower sweep time is used at voltages above. Or a more continuously changing sweep speed may be used in which the point-to-point timing changes from one point to the next. For example, point-to-point timing may be slow at the beginning of the sweep at Voc, then speed up more and more as the sweep progresses toward Isc. The changing point-to-point timing may be controlled to be, for example, linear, polynomial, exponential, or may follow any arbitrary profile.

An SMPC curve tracer 1404 overcomes limitations of existing art, including the following limitations: 1) active load curve tracer circuits cannot sweep a curve slow enough to avoid errors caused by the capacitance of HE modules without causing excessive heat to be generated in the pass-transistor, as discussed above; 2) pulsed loads are essentially very fast single point measurements made repeatedly at different load points but they cannot dwell long enough to avoid errors caused by the capacitance of HE modules without causing excessive heat to be generated in the pass-transistor, as discussed above; and 3) capacitive load I-V curve tracer circuits cannot sweep from Voc to Isc and cannot easily and arbitrarily set the I-V sweep speed.

During the sweep, a PV circuit voltage may be monitored and the sweep may be terminated when the PV circuit “short-circuit” condition (PV circuit voltage of zero) has been reached, which typically will be at a current less than the maximum measurement current allowed by the curve tracer circuitry (e.g., 30 amps). By starting from zero current and ramping up toward a maximum current and halting a sweep when either the maximum current has been reached or when the PV voltage reaches zero, the problem with a user applying too high of a current (e.g. attempting to measure four paralleled 10-amp strings with a device only rated for 30A) or forgetting to disconnect from an inverter when sweeping may be avoided.

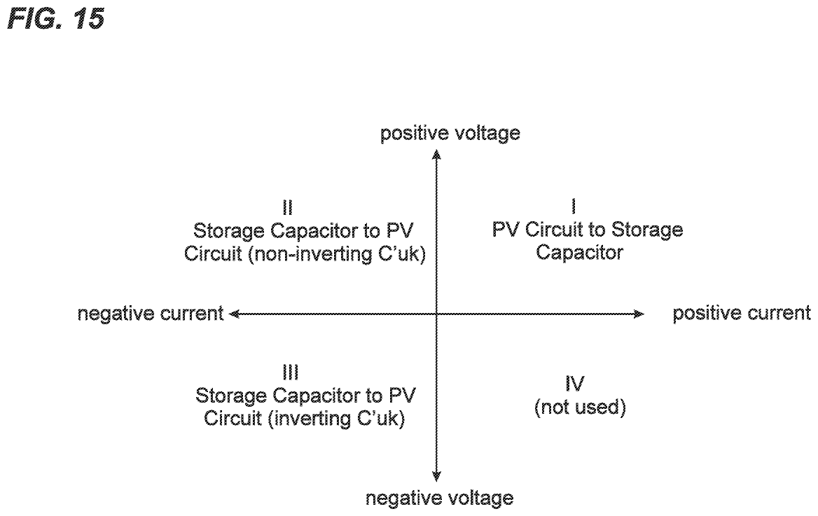

Various embodiments of the present disclosure use a “two-quadrant” SMPC topology to control the energy transfer from a PV circuit to a storage element in a low-loss fashion. The four possible quadrants of operation are illustrated in FIG. 15. A two-quadrant SMPC is a subset of a four-quadrant SMPC which may be substituted anywhere a two-quadrant SMPC is used.

Since an SMPC circuit is capable of two-quadrant operation, after the I-V sweep, during the bleed mode, the SMPC circuit may then switch the direction and transfer the stored energy in a storage capacitor back to a PV circuit at a rate that does not damage the measurement circuit or the PV cells or other components in the PV circuit. This “reverse transfer” is conceptually identical to how the previously described SMPC bleeder circuit may be operated, as described above. As a result, the SMPC circuit described above may include a 2-quadrant SMPC circuit that is configured to enable bidirectional energy transfer between the PV circuit under test and the load capacitor.

There are five basic SMPC topologies in the current art, from which nearly all SMPC approaches are derived: buck, boost, buck-boost, Sepic, and C'uk. The “flyback” converter discussed earlier is a variation on the boost converter. The various converter topologies have input and output current characteristics and limitations, that make them more or less suitable for two quadrant operation with continuous current and with minimal ripple current on the input which is desirable for this disclosure.

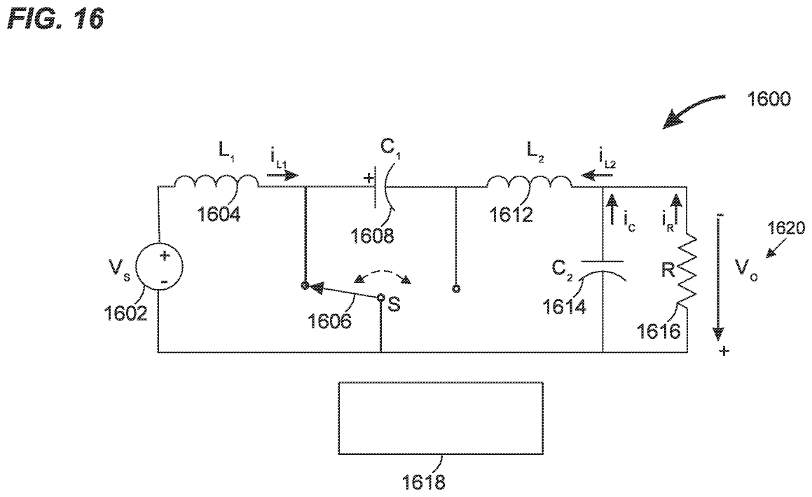

The C'uk converter is an attractive topology for embodiments of the present disclosure because both input and output currents are continuous, in contrast with other topologies where either the input current, output current, or in some cases both, occur in pulses. A basic C'uk schematic circuit 1600 is shown in FIG. 16. The basic C'uk schematic circuit 1600 includes a voltage source Vs 1602, an inductor L1 1604, a switch 1606, a capacitor C1 1608, an inductor L2 1612, a capacitor C2 1614, a resistor 1616, an SMPC controller 1618, and an output voltage Vo 1620. The SMPC controller 1618 may be configured to control the switch 1606.

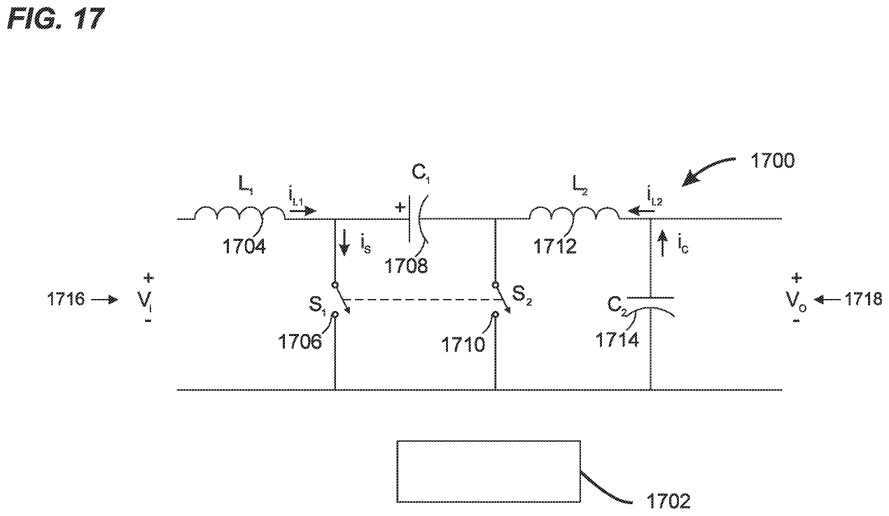

One embodiment of the present disclosure may use a second switching element 1710 as shown in a circuit 1700 of FIG. 17, enabling the converter to operate in the forward or reverse direction (i.e., two quadrants) to control current flow between the PV circuit under test and the load capacitor. Note that diode D 1610 in FIG. 16 described above only allows current flow in one direction. This is different from an ideal switch S2 1710, as shown in FIG. 17, in which current can flow in both directions when the switch is closed. In some embodiments, the switches may be transistors (e.g. BJTs, MOSFETs, IGBTs, or other suitable switching elements) and may include an internal anti-parallel diode.

The pair of switching elements S1 1706 and S2 1710 (see FIG. 17) operate in complimentary fashion. When switching element S1 1706 is closed, switching element S2 1710 is open, and vice versa. This allows circuit 1700 to operate in continuous conduction mode (meaning that current in inductors L1 and L2 are always continuous, and not pulsed), in two of the four quadrants of input vs output. In this way it can be either a “charger” or “discharger” circuit, depending on the input and output voltages and the duty-ratio supplied to the switching elements S1 1706 and S2 1710 by a SMPC controller 1702. This two-quadrant behavior is what enables the curve tracer with a single SMPC circuit block to either sweep the output of a PV circuit (i.e., as a load) or push stored energy after a sweep back into the PV circuit in a controlled fashion.

The C'uk converter shown in FIG. 17 inverts the voltage polarity from input to output. FIG. 17 includes an input voltage Vi 1716 and an output voltage Vo 1718. Since it is not strictly necessary for the input and output polarities to be the same in this application, one embodiment uses a “floating” drive circuit (not shown) for the second switching device; this allows the transistors for both switch S1 and switch S2 to be NPN or N-Channel devices. This class of devices offer better switching performance than if they were PNP or P-Channel devices.

One, non-limiting operation of circuit 1700 is as follows: with the polarity inverting C'uk topology, switching of switch S1 is initiated by a SMPC controller 1702, which turns switch S1 1706 ON. The current through switch S1 1706 is monitored by a high-bandwidth current-sensing circuit (not shown), which could be any of a number of common circuit elements, including a current-sense transformer or a current-sense resistor to name only two. When the sensed current reaches a desired threshold, switch S1 1706 is then turned OFF. The operation of switch S2 1710 is of opposite sense to that of switch S1 1706, as mentioned above, such that when switch S1 1706 is ON switch S2 1710 is OFF, and when switch S1 1706 is OFF, switch S2 1710 is ON. When switch S1 1706 is ON, current ramps up in inductor L1 1704. At substantially the same time, current may also flow through capacitor C1 1708 toward switch S1 1706 and that current may also flow through inductor L2 1712 toward switch S1 1706. Then, when switch S1 1706 is turned OFF, switch S2 1710 is turned ON, current in inductor L1 1704 may divert from switch S1 1706 through capacitor C1 1714 toward switch S2 1710. Simultaneously current in inductor L2 1712 may flow toward switch S2 1710. Note that current flow through capacitor C1 1714 reverses direction in this configuration of switch S1 1706 and switch S2 1710 from the previous direction. Because of the direction of current in inductor L2 1712, capacitor C2 1714 charges to a negative voltage. All of this causes a negative potential at the output side of the converter, which is why the basic C'uk converter circuit inverts the sense of voltage between input and output. SMPC controller 1702 may monitor the input current and voltage and the output current and voltage and repeatedly closes and opens switch S1 1706 and/or switch S2 1710 with varying duty cycles in a feedback loop that targets one or more current and voltage set-points. The above operation would be understood by one skilled in the art of switch mode power conversion and C'uk converter topologies.

A SMPC controller 1702 may be comprised of analog circuits, including one or more analog feedback loops, but it may also be a computer, processor, or digital signal processor (DSP) running software or firmware. Or an SMPC controller 1702 may be an Application Specific Integrated Circuit (ASIC), Field Programmable Gate Array (FPGA). or any other digital circuit. Or an SMPC controller 1702 may be an analog circuit or a mixed analog/digital circuit. In general, an SMPC controller 1702 may be any circuit or device capable of controlling the SMPC to transfer energy or to have one or more currents and/or voltages at its inputs and/or outputs.

In various embodiments the SMPC controller 1702 may be a feedback loop that servos (or controls) on current (e.g., it may adjust the switching duty cycle to achieve a certain input (or output) current). Alternatively, the SMPC controller 1702 may servo on input (or output) voltage. Alternatively, the SMPC controller 1702 may servo on input (or output) change-in-voltage with time (i.e., dv/dt) or change-in-current with time (i.e., di/dv). Servoing on the dv/dt may be useful in an I-V curve tracer because one of the important variables to control is the sweep time or more importantly the rate of change of voltage with time. This is particularly important to control near the max power point of the I-V curve. The rate of change of voltage at any given point on the I-V curve is the dv/dt at that point.

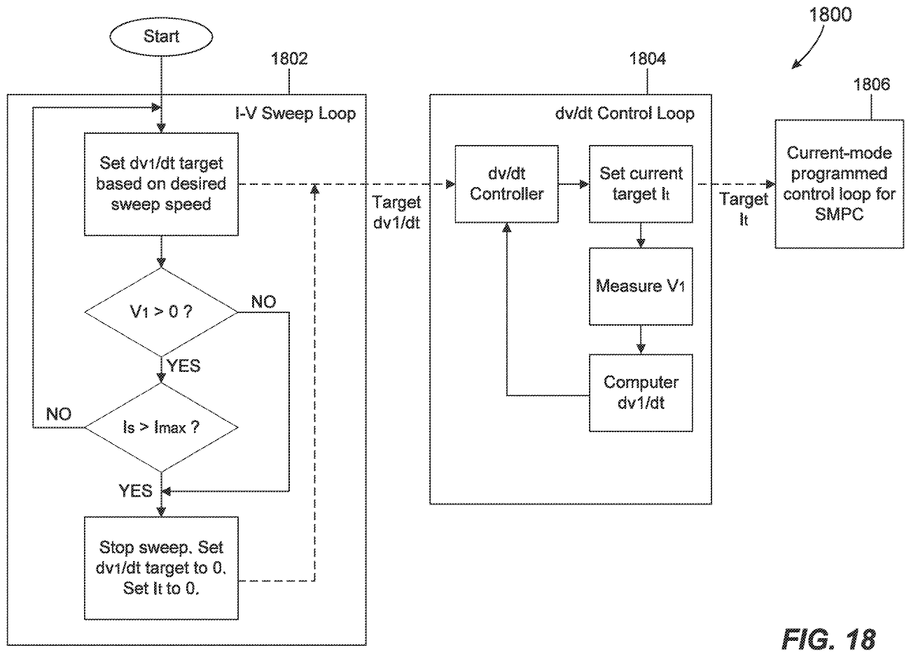

The SMPC controller 1702 may include multiple control feedback loops or loops within loops. In some embodiments the SMPC controller 1702 is configured to implement one or more of the control feedback loops described in connection with FIG. 18. For example, the SMPC controller 1702 may be configured to implement a control loop to control a rate of change of voltage with respect to time of the PV circuit under test to be within a predetermined range. For example, there may be an inner control loop 1806 that is receiving an input current target and then adjusting the switching duty cycle to achieve that target as discussed above. In some embodiments, the SMPC controller 1702 is a digital controller. In some embodiments, the SMPC controller 1702 includes analog circuitry.

In some embodiments, the switches used with the circuits 1600 and 1700 may be implemented using the switch 500 of FIG. 500. For example, in the switches of the C'uk converters, a floating drive output may be galvanically isolated from the control input.

In FIG. 18, an outer feedback control loop 1804 may receive a dv/dt target from an I-V sweep loop 1802 and then adjust a current target to achieve that dv/dt target. The outer loop feeds the current target to the inner loop. The outer loop may be an analog control loop or a digital (processor-controlled) control loop, for example, the well-known Proportional-Integral-Derivative (“PID”) algorithm, or a more complex control loop based on a Z-Transform approach implemented via software or firmware in a controller, or any other type of controller suitable for electronic feedback loops. The dv/dt target of the outer loop may be a changing target that is itself received from yet a third controller, or it may be following a pre-determined set of targets. For example, the first part of the I-V curve from Voc down to 0.8 Voc may be swept quickly (i.e., a high dv/dt) then from 0.8 Voc down to 0.6 Voc it may be swept slowly, then from 0.6 Voc down to Isc it may be swept quickly. This gets through the I-V curve sweep quickly to minimize energy storage requirements and/or heat dissipation, while sweeping slowly through the max power point to minimize curve distortion around that critical point.

As an example, an algorithm for an SMPC controller 1702 with multiple control feedback loops is shown in flowchart 1800 of FIG. 18.

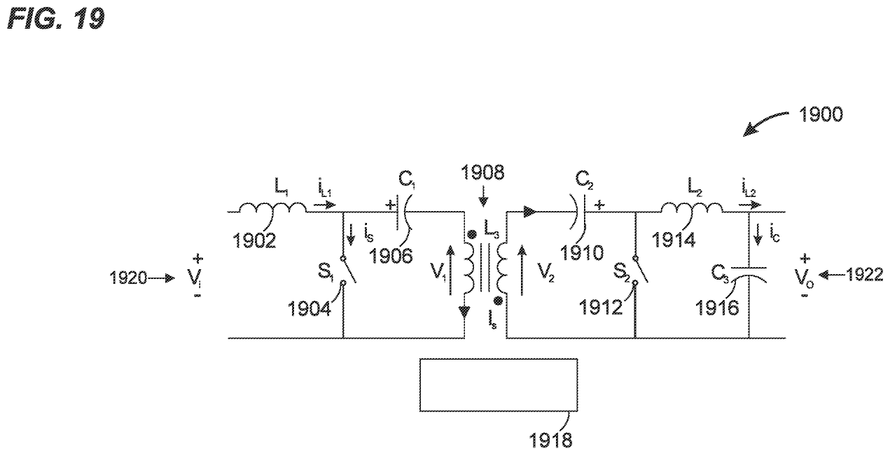

In another embodiment of SMPC circuit 1406 that uses the C'uk topology, it may be desired to preserve polarity between input and output. This may be accomplished by adding a suitable transformer, such as the polarity preserving transformer L 1908, which enables the circuit to have the same voltage polarity on the input and output sides of the circuit. FIG. 19 shows a polarity-preserving two-quadrant C'uk converter. Note that the addition of the transformer can enable “stacking” of two (or more) switching transistors in such a way as to allow switching of voltages greater than the voltage rating of any single device.

In various embodiments, a SMPC curve tracer 1404 applies a load starting at a voltage of Voc and current of zero, then the load is varied such that the voltage decreases from Voc to zero during a time period t1. For example, the SMPC curve tracer 1404 may use an SMPC curve tracer to apply a variable load during a sweep. (Note that there will be many cycles of the SMPC control loop during time period t1. The period of a switching cycle of the SMPC process is many times shorter than time t1.) During time period t1, the load capacitor is charged and the current and voltage is sampled at a sufficiently high sample rate (e.g., t1/100 to generate 100 current/voltage pairs or t1/1000 to generate 1000 pairs). Then, SMPC circuit 1406 changes direction (becoming a source) and bleeds a load capacitor down, transferring the energy back into the associated PV circuit during a time period t2. During time period t2, the voltage of the PV circuit may be higher than Voc while SMPC circuit 1406 is pushing energy into the PV circuit.

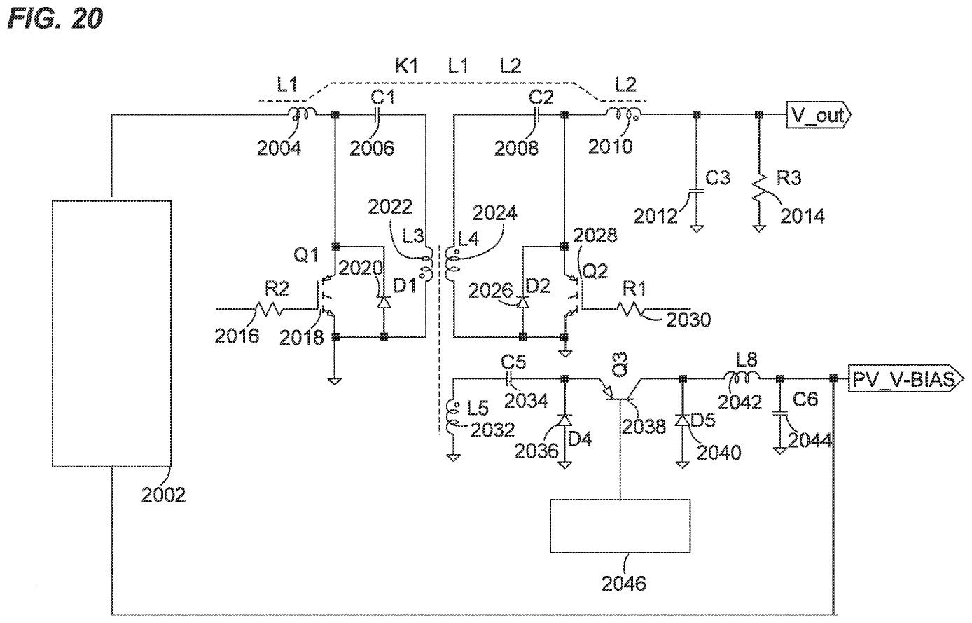

A simple C'uk topology (and virtually all other SMPC topologies), will have “ripple current” in the inductors used. This may make it difficult to make high-resolution current and voltage measurements during an I-V sweep and so the ripple current may be filtered out. According to various embodiments, an input ripple current may be steered to a part of the topology where it is harmless for purposes of sweeping a PV circuit. This may be achieved using a “coupled inductors” approach (as indicated in FIG. 20) for the input and output inductors, in conjunction with management of the “leakage inductance” between the two inductors, as would be understood by someone skilled in the art and as described in textbooks on SMPC converters and also in several papers by C'uk and Middlebrook describing the operation of the C'uk converter with coupled inductors.

In another embodiment, using a “polarity preserving” transformer L 1908 (see FIG. 19), ripple current can be made to be zero in both the input and output windings of the coupled inductors. FIG. 19 includes a circuit 1900, an inductor L1 1902, a switch S1 1904, a capacitor C1 1906, inductors L3 1908, a capacitor C2 1910, a switch S2 1912, an inductor L2 1914, a capacitor C3 1916, an SMPC controller 1918, an input voltage 1920, and an output voltage 1922.

In general, all SMPC topologies except the “buck” topology can have a “right-half plane zero” in the transfer function. The presence of such a right-half plane zero can make closing the control loop such that the loop is stable, challenging. In this disclosure, the control loop for an SMPC circuit may control in a non-conventional manner to achieve the desired I-V sweep characteristics. The essential elements of the control loop are that it controls via the (well-established) “current-mode programmed” approach, with the control-loop “target” current value being “swept” over a controllable time duration from zero current to a maximum measurement current for the I-V curve tracer (e.g., 30 amps or more). The target current for the control loop may be generated by a SMPC controller (e.g., under processor control), taking into account the dv/dt of the PV circuit output so as not to sweep so fast as to cause measurement errors. As part of this same control loop, the sweep may be stopped when the measured voltage of the PV circuit reaches zero, or when the maximum allowable current of the SMPC curve tracer is reached. By halting a sweep when the maximum allowable current is reached, problems, such as when a sweep is attempted while the PV circuit is still connected to an inverter input, may be avoided, as current will increase in a controlled fashion until the maximum allowed current is reached. The voltage at the termination of the (aborted) sweep could be anywhere on the I-V curve. By ramping current back down toward zero in a suitably controlled fashion, undesirable voltage transients can be minimized.

Once a sweep has been completed, the stored energy in a storage capacitor may be pumped back into the PV circuit. This may dissipate the stored energy in the huge surface area of the PV circuit and avoid internal heating of the curve tracer. This is similar to the operation of the “flyback” topology SMPC bleeder circuit, as described above. The advantage here is that no additional circuitry is needed; everything required is already present in the C'uk converter topology. Only suitable control algorithms executed by the already existing processor are needed.

A typical capacitive load curve tracer may have a capacitor-select switching matrix for selecting different series and parallel combinations of capacitors in order to achieve the proper voltage rating and sweep speed. Various embodiments of the present disclosure that use the SMPC approach can avoid the capacitor-bank switching matrix, allowing the use of fewer switching transistor elements and thereby saving cost.

The capacitor in a typical capacitive load curve tracer may be large enough to hold all of the charge of the full I-V sweep. This energy is the time integral of the power versus time curve. In one embodiment of the present disclosure, the SMPC storage capacitor is also sized to store all of the energy from the entire I-V sweep. In this case the SMPC curve tracer sweeps the entire I-V curve at one time during the “load” phase and then pushes the charge back into the PV circuit to discharge the capacitor during the “bleed down” phase.

When the SMPC reaches the end of the I-V curve sweep the voltage on the PV array is at or close to zero volts. In practice it is difficult to push the voltage all the way to zero volts with a SMPC. However, one of the important measurements of an I-V curve tracer is the short circuit current (“Isc”) where voltage is OV. Various embodiments of the present invention include a bias circuit. The bias circuit enables the SMPC I-V curve tracer to measure a true Isc by biasing the negative output of the PV array to a modest positive voltage, relative to the SMPC I-V curve tracer negative (“circuit common”) rail This is done to compensate for conduction losses in the SMPC I-V curve tracer circuit such that the voltage across the PV array can be driven to zero. The biasing may be done with a power supply or from a battery. Alternatively, it may be done by tapping off a small amount of the switching energy from the SMPC. One means of tapping off the small amount of energy for the bias circuit is to have an added winding on the polarity-inverting transformer in the C'uk implementation. The winding has its own C'uk capacitor and inductor as well as a separately-controlled switch for regulating the bias circuit voltage. Note, a PNP transistor Q3 2038 is shown in FIG. 20, but other circuit topologies including NPN or MOSFETs can be used as well. This separate circuit does not push its energy back into the PV array during storage capacitor discharge. FIG. 20 shows an example of this. FIG. 20 illustrates an example C'uk SMPC. FIG. 20 illustrates an example PV array 2002, inductor L1 2004, a capacitor C1 2006, a capacitor C2 2008, an inductor L2 2010, a capacitor C3 2012, a resistor R3 2014, a resistor R2 2016, a transistor Q1 2018, a diode D1 2020, an inductor L3 2022, an inductor L4 2024, a diode D2 2026, a transistor Q2 2028, a resistor R1 2030, an inductor L5 2032, a capacitor C5 2034, a diode D4 2036, a transistor Q3 2038, a diode D5 2040, an inductor L8 2042, a capacitor C6 2044, and a bias regulation unit 2046. In FIG. 20, the upper part is a detailed schematic drawing of a C'uk converter. The bias circuit is in the lower-right section of the schematic and shows one possible example of independent regulation of the bias voltage. Other means are of course also possible. Do note that this diagram shows an example of a “coupled inductor” concept in the C'uk converter which is useful for steering the undesirable ripple current in the input inductor away from the input inductor toward the output inductor. In the output inductor the ripple current is harmless in terms of measurement “noise”.

### Two Quadrant SMPC Curve Tracer without Storage Capacitor

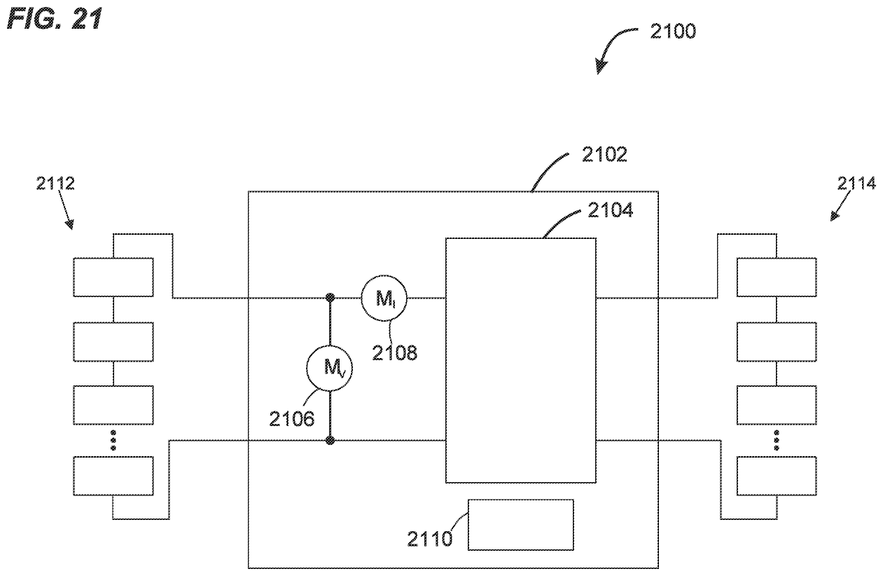

In another embodiment of a device 2100 shown in FIG. 21, two independent PV circuits (e.g., two separate strings) are connected to an SMPC curve tracer 2102. One PV circuit “PV Circuit 2112” is the source and another PV circuit “PV Circuit 2114” is the load. The SMPC curve tracer 2102, including an SMPC 2104 sweeps the I-V Curve of PV Circuit 2112 and simultaneously transfers the energy to PV Circuit 2114. The SMPC curve tracer 2102 further includes a voltage sensing element Mv 2106, a current sensing element M_{I} 2108, and a curve tracer controller 2110. An advantage of this embodiment is that a storage capacitor may not be necessary, and the bleed mode may not be necessary. This reduces measurement time and saves cost, space and weight in the SMPC curve tracer 2102. After the I-V curve of PV Circuit 2112 is swept and the energy pushed into PV Circuit 2114, then the SMPC curve tracer 2102 can reverse the direction and sweep the I-V curve of PV Circuit 2114 and push the energy into PV Circuit 2112. In this mode, PV Circuit 2114 becomes the source and PV Circuit 2112 becomes the load. This has the advantage that the user can connect two PV circuits to the curve tracer once and both PV circuits get their I-V curves swept without changing the connections, thus allowing for faster characterization of PV circuits (e.g., in a solar farm).

### Two Quadrant SMPC Curve Tracer with Piecewise I-V Sweeps

In another embodiment, A SMPC curve tracer sweeps sub-sections of the I-V curve (c.g. 25% or 50% of the energy of the full curve). The curve tracer may start at Voc and sweep down to a voltage less than Voc but substantially higher than 0 V and stop. Alternatively, the curve tracer may start at a voltage substantially less than Voc and sweep down to 0V. Alternatively, curve tracer may start at an arbitrary first voltage and sweep up or down to an arbitrary second voltage. In some embodiments an SMPC curve tracer sweeps a sub-section of the I-V curve in a Sweep Mode, then pushes the charge back into the PV circuit in a Bleed Mode (or into a different PV circuit as described above), then sweeps a different section of the I-V curve and pushes that charge back into the array (or into a different PV circuit). This may repeat until the entire I-V curve has been swept.

For example, the SMPC curve tracer may sweep a first part of the I-V curve from an open circuit voltage to a non-zero voltage lower than the open circuit voltage. As another example, the SMPC curve tracer may sweep a first part of an I-V curve from a first voltage that is lower than the open circuit voltage to a second voltage that is lower than the first voltage. Furthermore, in some embodiments, the SMPC curve tracer is configured to transfer energy into a PV circuit under test (or into a different PV circuit) before sweeping a second part of the IV curve. The second part of the IV curve may be different than the first part of the IV curve.

One benefit of this approach is that a storage capacitor may have a lower capacitance, saving cost, space (e.g., volume), and weight. For example, if 50% of the energy of the I-V curve is swept and then the storage capacitor is bled down and then the other 50% is swept, then, in this case, the storage capacitor may be approximately half the size compared to the storage capacitor required to sweep 100% of the I-V curve all at once.

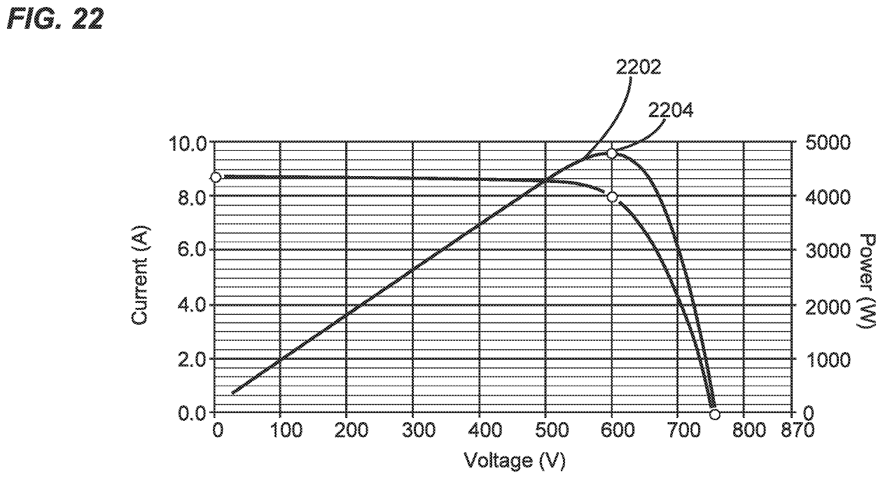

An I-V curve has a corresponding P-V (power versus voltage) curve 2202 as shown in a plot of FIG. 22. The maximum power is indicated by dot 2204 in the plot of FIG. 22. The energy transferred from a PV circuit into an I-V curve tracer is the integral of the P-V curve 2202 with time. As the I-V curve is being swept, the power being fed into a storage capacitor follows the P-V curve. It starts at zero at the beginning of the I-V sweep at Voc (i.e., on the right side of the plot of FIG. 22) and ramps up as voltage decrease to a maximum “Pmax” (dot 2204) equal to the max power voltage times the max power current around the “knee” in the I-V curve, then ramps back down to zero at the end of the I-V curve at Isc. The energy stored in the storage capacitor is the power integrated over time during the I-V sweep as discussed above.

One challenge with sweeping an I-V curve in sections (e.g., 50% at a time) is that when the I-V curve sweep is interrupted, then re-started, the current flowing is interrupted and then restarted. During the time in between the two sections, when the storage capacitor is being bleed down, the PV circuit returns to Voc or higher than Voc if the bleed down is happening by pushing the energy back in to the PV circuit. Then, the curve sweep resumes, and current again flows into the curve tracer and storage capacitor. When current flow re-starts rapidly there may be an in-rush current from the capacitance of the HE modules if a low-impedance load in the curve tracer is applied to the PV circuit very rapidly. Therefore, in various embodiments of a SMPC curve tracer, a gentler ramping up of current may be controlled. This may spread out the inrush current pulse over time, reducing the peak current, and making it easier to handle in circuitry. It may result in more energy stored in the capacitor, however.

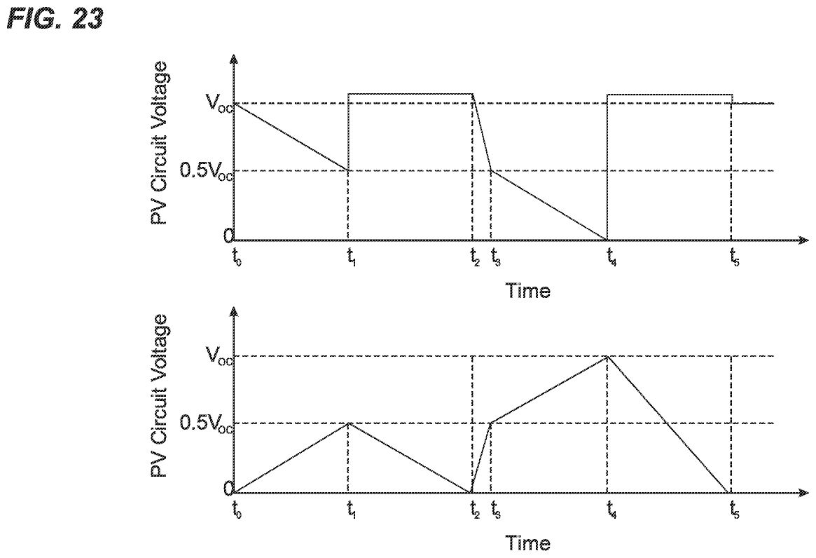

With reference to FIG. 23, in one example, a SMPC curve tracer applies a load starting at a voltage of Voc and current of zero (i.e., open circuit), then the load may be varied such that the voltage decreases from Voc at time t0 to 0.5 Voc at a time t1. The voltage of the PV circuit and storage capacitor is shown in FIG. 23 as an illustrative example (not to scale). During the time period from t0 to t1, the storage capacitor is charged and the current and voltage are sampled at a sufficiently high sample rate (e.g. (t1−t0)/100 to generate 100 current & voltage pairs or (t1−t0)/1000 to generate 1000 pairs). Note that the time between each sample-pair is not the same as the time of a cycle of the SMPC circuit—they are independent. Then, starting at time t1, the SMPC circuit changes direction and bleeds the storage capacitor down, transferring the energy from the storage capacitor back into the PV circuit. During time period from t1 to t2 the voltage of the PV circuit may be higher than Voc while the SMPC circuit is pushing energy into the PV circuit. Next, the SMPC circuit reverses direction again, picking up where it left off at 0.5Voc. It may change the load rapidly from Voc to 0.5Voc (e.g., in 1 us) or it may change the load more slowly to limit the in-rush current as shown in FIG. 23 from time t2 to t3. It would generally not take as long as the time period from t0 to t1 to get back to 0.5Voc, because if it did, then the storage capacitor would fill up again before the voltage makes any progress beyond 0.5Voc. But it may be a fraction of the period from t0 to t1, for example 10% or 1% of the period from t0 to t1 which would (as is preferred) only transfer a small amount of energy into the storage capacitor. Then, at time t3, the SMPC circuit continues to reduce the voltage from 0.5Voc to 0 at time t4 while measuring current and voltage at a sufficiently high sample rate. Then, at time t4, the SMPC circuit again changes direction and transfers the energy in the storage capacitor back into the PV circuit over a time period from t4 to t5. Then, at time t5, the PV circuit is returned to Voc.

In the example of FIG. 23, the I-V sweep is broken into five time periods in which two of the time periods are progressing through the I-V sweep from Voc to a fraction, 0.5, of Voc and then from the fraction of Voc, 0.5, to 0. However, in other examples, the I-V curve may be broken up into any number of time periods and the fraction of the I-V curve voltage may be any fraction from 0 to 1. Furthermore, the fractions of the I-V curve swept during the various periods may be the same fractional amount or may be different fractional amounts. Also, the voltage may not increase linearly as shown in FIG. 23, but may follow an exponential curve or other shape. Also, in this example, the I-V curve was divided up by voltage (i.e., fractions of Voc), but it may, alternatively, be divided by energy transferred, as discussed above. It could also be divided up by current or some other parameter. The energy or other parameter may ramp up linearly or exponentially, or follow any profile.

In one embodiment of the present invention an SMPC curve tracer is controlled to slowly and/or repeatedly sweep a specific narrow region of the I-V curve. This may help excite issues with the PV circuit that may not appear in a normal I-V curve sweep such as ground faults or arc faults that are more likely to appear under load and at certain voltages. For example, the region just below Voc may be more likely to uncover issues triggered by high voltages such as ground faults or arc faults. For example, the SMPC curve tracer may sweep from 0.9 Voc to Voc slowly (e.g., in 500 ms). Or it may sweep it repeatedly, moving the voltage from Voc to a lower voltage (e.g., 0.9Voc) slowly (e.g., in 500 ms) then reversing direction and sweeping from the lower voltage back to Voc slowly. As another example, the SMPC curve tracer may adjust the sweep speed as it repeats the sweep back and forth between Voc and the lower voltage. The present invention includes a dual-channel simultaneous sampling high-speed ADC (e.g., 50-100 MSPS), enabling detection of rapidly changing current or voltage events that may be indicative of a ground fault, arc fault, or other problem in the PV circuit.

In another example, the region around the max power point (e.g. 0.6 Voc to 0.8 Voc) is swept repeatedly but each time at different rates (dv/dt). By analyzing the measured current at different dv/dt rates, the efficiency of the modules being measured may be determined. Higher efficiency modules exhibit higher capacitance and also distort the I-V curve more. When swept from Isc to Voc, a high efficiency module will produce a lower and lower current around the MPP as the dv/dt is higher and higher. When swept in the opposite direction from Voc to Isc, a high efficiency module will produce a higher and higher current around MPP as the dv/dt is higher and higher.

FIG. 24 illustrates an example trace 2400 of current and voltage over time that may be detected and traced by an I-V curve tracer described herein or by an oscilloscope external to an I-V curve tracer. In the example trace 2400, the current has an in-rush current transient 2402.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to some embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds truc for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction Is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated some embodiments, those of ordinary skill in the art will recognize and appreciate that the present invention is not so limited. Rather, many additions, deletions, and modifications to the illustrated and described some embodiments may be made without departing from the scope of the invention as hereinafter claimed along with their legal equivalents. In addition, features from one some embodiment may be combined with features of another some embodiment while still being encompassed within the scope of the invention as contemplated by the inventor.

### Aspects of the Disclosure

Some aspects of the present disclosure are listed below. One aspect is a device for tracing current-voltage (IV) curves. The device includes a switch-mode power converter (SMPC) circuit, a load capacitor coupled to the SMPC circuit, and a controller, coupled to the SMPC circuit and the load capacitor. The controller may be configured to sweep an IV curve of a PV circuit under test in a sweep mode, and optionally to control the SMPC circuit to transfer energy from the load capacitor to the PV circuit under test in a bleed mode. The device optionally includes a switch, coupled to the load capacitor, configured to be in a closed state in the sweep mode to charge the load capacitor, and in an open state in the bleed mode to discharge the load capacitor. The SMPC circuit optionally includes a flyback power converter to cause a current to flow from the load capacitor into the PV circuit under test. The SMPC circuit is optionally configured to transfer energy from the PV circuit under test to the load capacitor in the sweep mode, and to optionally transfer energy from the load capacitor to the PV circuit under test in the bleed mode. The SMPC circuit optionally comprises a 2-quadrant SMPC circuit configured to enable bidirectional energy transfer between the PV circuit under test and the load capacitor. The SMPC circuit optionally comprises a C'uk converter configured to operate in a forward direction or a reverse direction to control current flow between the PV circuit under test and the load capacitor. The controller is optionally configured to sweep a first part of the IV curve from an open circuit voltage to a non-zero voltage lower than the open circuit voltage, or from a first voltage lower than open circuit voltage to a second voltage lower than the first voltage. The controller is optionally configured to transfer energy from the load capacitor to the PV circuit under test before sweeping a second part of the IV curve that is different from the first part of the IV curve. The controller is optionally configured to implement a control loop to control a rate of change of voltage with respect to time of the PV circuit under test to be within a predetermined range. The controller is optionally a digital controller, or optionally includes analog circuity.

Another aspect is a tracer for tracing IV curves. The tracer includes a controller and a measurement circuit, and optionally an in-rush shunt circuit, wherein the controller, coupled to the measurement circuit and the in-rush shunt circuit, may be configured to charge a load capacitor in a sweep mode based in part by controlling the in-rush shunt circuit to shunt an in-rush current away from the measurement circuit. The tracer optionally includes a bleeder circuit, wherein the controller is further optionally configured to discharge the load capacitor in a bleed mode based in part on the bleeder circuit. The in-rush shunt circuit optionally includes an electronic switch that is closed for a period by a shunt controller in the sweep mode. The in-rush shunt circuit optionally includes an electronic switch, and the controller is optionally configured to close the electronic switch for a period in the sweep mode. The tracer optionally includes a load capacitor coupled with the in-rush shunt circuit. The controller is optionally configured to apply a load capacitor to a PV circuit under test with a module level electronics (MLE) until the MLE powers off, remove the load capacitor until the MLE powers on; reapply the load capacitor until the MLE powers off; and remove the load capacitor until the MLE powers on. The controller is optionally configured to repeat: (i) apply a load capacitor to a photovoltaic (PV) circuit including module level electronics (MLE) until the MLE powers off; (ii) remove the load capacitor until the MLE powers on; and (iii) repeat steps (i) and (ii) until a voltage on the load capacitor reaches an open circuit voltage. The controller is optionally configured to sweep an I-V curve of photovoltaic (PV) circuit including module level electronics (MLE) by applying a load capacitor to the PV circuit repeatedly with a pulsed switch until a voltage on the load capacitor reaches a pre-determined voltage.

Another aspect is a system for testing photovoltaic (PV) modules. The system includes a device for tracing IV curves, and optionally includes an instrument to measure a property associated with a PV module having the PV circuit under test. The system optionally includes a processor or a display. The processor is optionally configured to present a real-time test progression of at least a part of the IV curve on the display. The instrument optionally comprises a plurality of sensors coupled to different parts of the PV module to collect sensor data associated with the PV module, and the instrument is further optionally configured to determine the property associated with the PV module based on the sensor data. The property may include one or more measurements of irradiance, module temperature, or array tilt associated with the PV module. The instrument is optionally configured to transmit the one or more measurements to the device via a wired or wireless connection. The device is optionally configured to form a wireless network for the instrument to communicate with the device.

Another aspect is a method for tracing current-voltage (IV) curves. The method may include steps of sweeping an IV curve by using a switch-mode power converter (SMPC) circuit to transfer energy from a photovoltaic (PV) circuit under test into a storage element, and transfer energy stored in the storage element into the PV circuit. Alternatively, the method may include steps of using a switch-mode power converter (SMPC) circuit in a tracer to conduct bidirectional energy transfer between a photovoltaic (PV) circuit under test and an energy storage element in a tracer. Alternatively, the method may include steps of conducting, based on a switch-mode power converter (SMPC) circuit in a tracer, a bidirectional energy transfer process between a photovoltaic (PV) circuit under test and an energy storage element in the tracer. Alternatively, the method may include steps of sweeping, using a switch-mode power converter (SMPC) circuit, a photovoltaic (PV) circuit under test to transfer energy from the PV circuit into a storage element; and optionally transferring energy stored in the storage element into the PV circuit. The method optionally includes sweeping the PV circuit under test comprises controlling a sweep speed. During the sweeping, the method optionally includes controlling one or more of a starting current or ending current; or setting one or more of a starting voltage or ending voltage. The method optionally includes monitoring a voltage of the PV circuit; or terminating a sweep of the PV circuit when the voltage of the PV circuit is zero. The method optionally includes implementing a control loop to control a rate of change of voltage with time. The control loop is optionally configured to receive a target rate of change of voltage with time, or adjust a current target to achieve the target rate of change of voltage with time. The control loop optionally comprises an outer control loop configured to provide the current target to an inner control loop configured to adjust a switching duty cycle based on the current target. During the sweeping, the SMPC circuit may be used to apply a variable load. The storage element can be a storage or load capacitor.

1. A device for tracing current-voltage (IV) curves, comprising:
a switch-mode power converter (SMPC) circuit;
a load capacitor coupled to the SMPC circuit; and
a controller, coupled to the SMPC circuit and the load capacitor, configured to sweep an IV curve of a PV circuit under test in a sweep mode, and to control the SMPC circuit to transfer energy from the load capacitor to the PV circuit under test in a bleed mode.

2. The device of claim 1, further comprising:
a switch, coupled to the load capacitor, configured to be in a closed state in the sweep mode to charge the load capacitor, and in an open state in the bleed mode.

3. The device of claim 1, wherein the SMPC circuit comprises a flyback power converter to cause a current to flow from the load capacitor into the PV circuit under test.

4. The device of claim 1, wherein the SMPC circuit is configured to transfer energy from the PV circuit under test to the load capacitor in the sweep mode, and to transfer energy from the load capacitor to the PV circuit under test in the bleed mode.

5. The device of claim 4, wherein the SMPC circuit comprises a 2-quadrant SMPC circuit configured to enable bidirectional energy transfer between the PV circuit under test and the load capacitor.

6. The device of claim 4, wherein the SMPC circuit comprises a C'uk converter configured to operate in a forward direction or a reverse direction to control current flow between the PV circuit under test and the load capacitor.

7. The device of claim 4, wherein the controller is configured to sweep a first part of the IV curve from an open circuit voltage to a non-zero voltage lower than the open circuit voltage, or from a first voltage lower than open circuit voltage to a second voltage lower than the first voltage.

8. The device of claim 7, wherein the controller is further configured to transfer energy from the load capacitor to the PV circuit under test before sweeping a second part of the IV curve that is different from the first part of the IV curve.

9. The device of claim 1, wherein the controller is configured to implement a control loop to control a rate of change of voltage with respect to time of the PV circuit under test to be within a predetermined range.

10. The device of claim 1, wherein the controller is a digital controller, or the controller includes analog circuity.

11. A system for testing photovoltaic (PV) modules, comprising:
the device of any one of the proceeding claims; and
an instrument, coupled to the device, to measure a property associated with a PV module that is a part of the PV circuit under test.

12. The system of claim 11, further comprising:
a computing device having a processor and a display, wherein the processor is configured to present a real-time test progression of at least a part of the IV curve on the display.

13. The system of claim 11, wherein the instrument comprises a plurality of sensors coupled to different parts of the PV module to collect sensor data associated with the PV module, and the instrument is further configured to determine the property associated with the PV module based on the sensor data.

14. The system of claim 11, wherein the property comprises one or more measurements of irradiance, module temperature, or array tilt associated with the PV module, and the instrument is configured to transmit the one or more measurements to the device via a wired or wireless connection.

15. The system of claim 11, wherein the device is configured to form a wireless network for the instrument to communicate with the device.
